(19) United States
(12) Patent Application Publication
(10) Pub. No.: US 2022/0405335 A1
(43) Pub. Date: Dec. 22, 2022

(54) INFORMATION PRESENTATION METHOD, RECORDING MEDIUM, AND INFORMATION PRESENTATION SYSTEM

(71) Applicant: Panasonic Intellectual Property Management Co., Ltd., Osaka (JP)

(72) Inventors: Michiko SASAGAWA, Osaka (JP); Mitsuhiro ASO, Shiga (JP); Naohisa TANABE, Osaka (JP); Nobue NARITA, Osaka (JP)

(21) Appl. No.: 17/770,912

(22) PCT Filed: Feb. 25, 2021
(86) PCT No.: PCT/JP2021/007203

§ 371 Date: Apr. 21, 2022

(30) Foreign Application Priority Data
Feb. 26, 2020 (JP) 2020-030918
Feb. 25, 2021 (JP) 2021-028031

(51) Int. Cl. G06F 16/9535; G06F 16/9538; G06F 16/903

(52) U.S. Cl. CPC G06F 16/9535; G06F 16/9538; G06F 16/90335

(57) ABSTRACT

An information presentation method is an information presentation method of presenting a user with a meal proposal selected from a plurality of meal proposals, and the information presentation method includes: obtaining user information associated with the user; determining condition information associated with the user based on the user information obtained and determining a plurality of intermediate words based on the condition information; presenting the user with the plurality of intermediate words; determining, of the plurality of meal proposals, a meal proposal corresponding to one or more intermediate words selected by the user; and presenting the user with the meal proposal determined. Each of the plurality of intermediate words is a word that corresponds to an attribute pertaining to one or more meal proposals among the plurality of meal proposals.

### CROSS-REFERENCE OF RELATED APPLICATIONS

This application is the U.S. National Phase under 35 U.S.C. § 371 of International Patent Application No. PCT/JP2021/007203, filed on Feb. 25, 2021, which in turn claims the benefit of Japanese Patent Application No. 2020-030918, filed on Feb. 26, 2020, and Japanese Patent Application No. 2021-028031, filed Feb. 25, 2021, the entire disclosures of which Applications are incorporated by reference herein.

### TECHNICAL FIELD

The present disclosure relates generally to information presentation methods, recording media, and information presentation systems. More specifically, the present disclosure relates to an information presentation method, a recording medium, and an information presentation system for presenting a user with an item of presentation information selected from items of presentation information.

### BACKGROUND ART

Patent Literature (PTL) 1 discloses a music search system. This music search system manages music data and 5W1H information with the music data and the 5W1H information associated with each other and can search for a piece of music that matches the preferences or the situation of the user based on a 5W1H search keyword. In this music search system, an information terminal includes a search requester, a music player, and a library registerer. The search requester requests a search for a piece of music in response to receiving an input of 5W1H information from the user. The music player plays the piece of music. The library registerer registers a desired piece of music into a library.

### CITATION LIST

### Patent Literature

[PTL 1]

International Publication No. 2017/033220

### SUMMARY OF INVENTION

### Technical Problem

The music search system disclosed in PTL 1 has shortcomings in that the user himself or herself is tasked with inputting 5W1H information into the search requester in order to obtain a search result for music.

The present disclosure has been made in view of the above circumstances and is directed to providing an information presentation method, a recording medium, and an information presentation system that each offer improved user-friendliness and allow the user's intention to be reflected more readily.

### Solution to Problem

An information presentation method according to one aspect of the present disclosure is an information presentation method of presenting a user with a meal proposal selected from a plurality of meal proposals, and the information presentation method includes: obtaining user information associated with the user; determining condition information associated with the user based on the user information obtained and determining a plurality of intermediate words based on the condition information; presenting the user with the plurality of intermediate words so as to allow the user to select one or more intermediate words from the plurality of intermediate words; determining, of the plurality of meal proposals, a meal proposal corresponding to the one or more intermediate words selected by the user; and presenting the user with the meal proposal determined, wherein each of the plurality of intermediate words is a word that corresponds to an attribute pertaining to one or more meal proposals among the plurality of meal proposals.

A recording medium according to one aspect of the present disclosure is a non-transitory computer readable recording medium having recorded thereon a program that causes one or more processors to execute the above information presentation method.

An information presentation system according to one aspect of the present disclosure is an information presentation system that presents a user with a meal proposal selected from a plurality of meal proposals pertaining to a meal, and the information presentation system includes: an obtainer that obtains user information associated with the user; a first determiner that determines condition information associated with the user based on the user information obtained and determines a plurality of intermediate words based on the condition information; a first presenter that presents the user with the plurality of intermediate words so as to allow the user to select one or more intermediate words from the plurality of intermediate words; a second determiner that determines, of the plurality of meal proposals, a meal proposal corresponding to the one or more intermediate words selected by the user; and a second presenter that presents the user with the meal proposal determined, wherein each of the plurality of intermediate words is a word that bears an association with an attribute pertaining to one or more meal proposals among the plurality of meal proposals.

### Advantageous Effects of Invention

The present disclosure provides advantageous effects of offering improved user-friendliness and allowing the user's intention to be reflected more readily.

### BRIEF DESCRIPTION OF DRAWINGS

FIG. 1 is a schematic configuration diagram of an information presentation system according to one embodiment.

FIG. 2 is a block configuration diagram of a presentation device in the information presentation system according to the embodiment.

A to C in FIG. 3 are conceptual diagrams for describing, respectively, a group that includes a plurality of users, condition information, and an attribute in the information presentation system according to the embodiment.

FIG. 4 is an illustration for describing a screen shift in the presentation device according to the embodiment.

FIG. 5 is a sequence diagram for describing an example of an operation of the information presentation system according to the embodiment.

FIG. 6 is an illustration for describing a variation of the presentation device according to the embodiment.

FIG. 7 is an illustration for describing another variation of the presentation device according to the embodiment.

FIG. 8 is a block diagram illustrating a functional configuration of a presentation system according to a specific example of the embodiment.

FIG. 9 is a flowchart illustrating an operation of an information presentation system according to a specific example of the embodiment.

FIG. 10 is a diagram illustrating an example of how an intermediate word is deleted according to a specific example of the embodiment.

FIG. 11 is a diagram illustrating an example of a do-not-display list according to a specific example of the embodiment.

FIG. 12 is a flowchart illustrating an operation pertaining to how an intermediate word is deleted according to a specific example of the embodiment.

FIG. 13 is a diagram illustrating an example of how an intermediate word is updated according to a specific example of the embodiment.

FIG. 14 is a flowchart illustrating an operation pertaining to how an intermediate word is updated according to a specific example of the embodiment.

FIG. 15 is a diagram illustrating an example of intermediate words presented in a manner corresponding to the values of the foodstuffs according to a specific example of the embodiment.

FIG. 16 is a diagram illustrating an example of intermediate words presented based on user information according to a specific example of the embodiment.

### DESCRIPTION OF EMBODIMENTS

### (1) Overview

The drawings referred to in the description of the following embodiments are schematic diagrams, and the ratio of the dimensions or the thicknesses of the constituent elements illustrated in the drawings does not necessarily reflect the actual dimensional ratio.

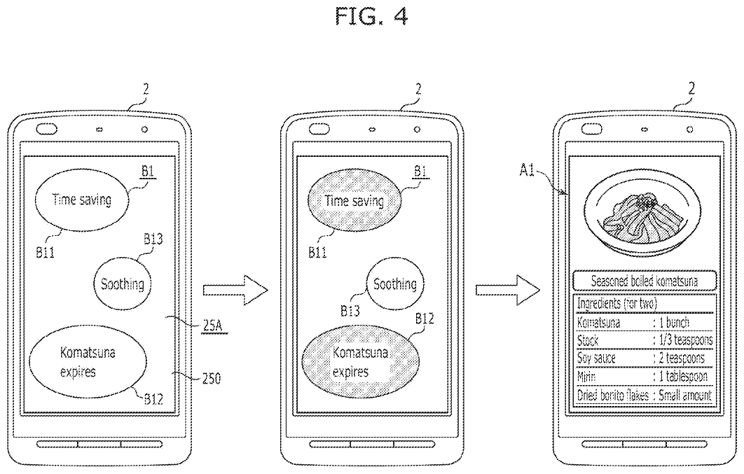

An information presentation method according to one implementation of the present embodiment is a method of presenting user 5 with an item of presentation information A1 (see FIG. 4) selected from multiple items of presentation information A1. Herein, in one example, presentation information includes meal information pertaining to a meal, and in particular, meal information includes information pertaining to, for example but not limited to, a menu item to be cooked or a combination of menu items to be cooked. Moreover, meal information includes information pertaining to a recipe (how to cook a given menu item) or information pertaining to a home meal replacement or an eat out (store information about a restaurant or the like), in addition to a menu item to be cooked. In the following description, a menu item to be cooked and a recipe therefor may be collectively referred to simply as a menu regardless of the number of items on the menu, and a proposal pertaining to presentation information A1 may be referred to as a menu proposal.

What is included in presentation information A1 is not limited to meal information pertaining to a meal. Presentation information A1 may include information pertaining to music, a book, a video, or the like, in place of information pertaining to a meal. The present embodiment assumes that the information presentation method provides meal information, for example, for the day, for the next day, or for an extended period of time, such as for one week or for one month.

The information presentation method includes a first determining step, a first presenting step, a second determining step, and a second presenting step.

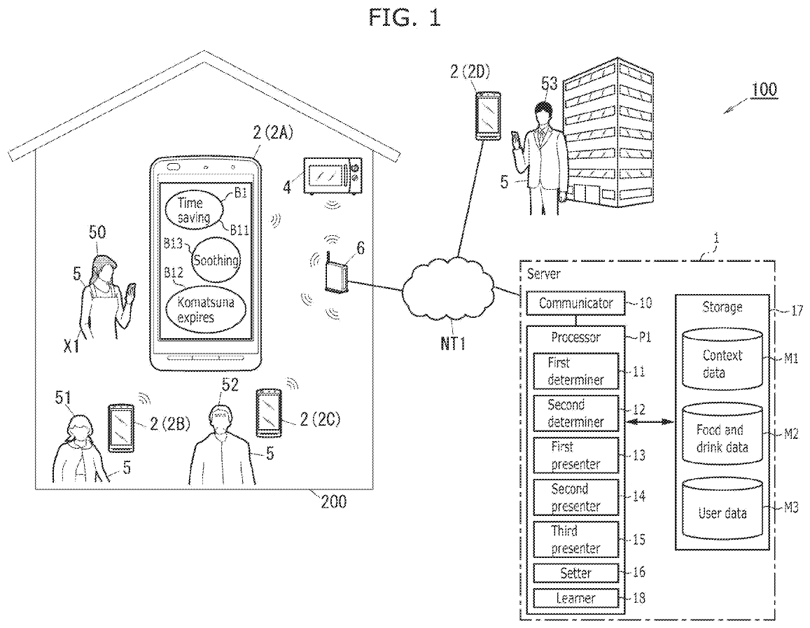

At the first determining step, a plurality of intermediate words B1 are determined based on condition information C1 (see B in FIG. 3) associated with user 5 (see FIG. 1). In one example described herein, the information presentation method is used with a focus on a family in home 200. In other words, the information presentation method is used for the unit of group G1 (one household) that includes a plurality of users 5 (mother 50, father 53, child 51, and grandfather 52). There is no particular limitation on the number of users 5, however, and the information presentation method may be used for the unit of one user or for the unit of an organization or an association.

Condition information as used herein is information (obtained information) pertaining to at least one of a user situation, a stocking situation, or an environmental situation, and such information is used to determine whether a predetermined condition is satisfied. Information pertaining to a user situation includes, for example, information pertaining to the current location (the current position) of user 5 and information pertaining to the state of health or the like of user 5. Information pertaining to a stocking situation includes, for example, information pertaining to the type of foodstuffs stocked at home 200 (in a freezer, a refrigerator, or the like in home 200) or the manage-by date of such foodstuffs (specifically, the expiration date, the best-before date, or the like). Information pertaining to an environmental situation includes, for example, information pertaining to the environment surrounding home 200 or the temperature, the humidity, the season, or the like surrounding user 5.

At the first presenting step, user 5 is presented with a plurality of intermediate words B1 such that user 5 can select one or more intermediate words B1 from the plurality of intermediate words B1. According to the present embodiment, a plurality of intermediate words B1 are output to (presented on) outputter 25 of presentation device 2, and this presentation device 2 corresponds to an information terminal owned (e.g., carried) by user 5.

An information terminal as used herein is, for example but not limited to, a smartphone or a tablet terminal. An assumption herein is that the presenting is performed, for example, via a screen output on display 25A (see FIG. 4) that includes a touch panel liquid crystal display or an organic electroluminescence (EL) display. Presentation device 2, however, is not limited to a portable terminal and may instead be, for example, a desktop personal computer. The mode of the presenting is not limited to a screen output, and the presenting may be performed via an audio output in place of or in addition to a screen output. For example, presentation device 2 may be a smart speaker adopting an artificial intelligence (AI) technology, that is, may be a so-called an AI speaker. Presentation device 2 may be a smart TV. In a case where presentation device 2 is not a portable terminal, presentation device 2 may be installed in the kitchen of home 200.

At the second determining step, of the items of presentation information A1, an item of presentation information A1 that corresponds to one or more intermediate words B1 selected by user 5 is determined. At the second presenting step, the determined item of presentation information A1 is presented to user 5. At the second presenting step as well, basically, the determined item of presentation information A1 is presented via same presentation device 2 as presentation device 2 that has presented the plurality of intermediate words B1 at the first presenting step. According to one example of presentation information A1 (meal information), presentation information A1 may include information (text information or image information) pertaining to a menu item to be cooked that is called a seasoned boiled komatsuna (see FIG. 4). In addition, presentation information A1 may include, for example, information (text information and image information) pertaining to a recipe for (how to cook) the seasoned boiled komatsuna.

Where the information is presented at the first presenting step may differ from where the information is presented at the second presenting step. For example, information may be presented at the first presenting step via a smartphone owned by user 5, whereas information may be presented at the second presenting step via a smart TV owned by user 5. In addition, presentation information A1 presented at the second presenting step is not limited to one item of presentation information A1, and multiple items of presentation information A1 may be presented at the second presenting step.

In this example, each of the plurality of intermediate words B1 is a word that bears an association with attribute D1 (see C in FIG. 3) pertaining to one or more items of presentation information A1 among the items of presentation information A1. Presentation information A1 (meal information) may include a plurality of attributes D1, including, for example, foodstuffs necessary for a given menu item to be cooked, the cooking time for the menu item to be cooked, the temperature of the menu item to be cooked, and the season (the time of the year) when the menu item to be cooked is cooked. For example, if attribute D1 pertains to foodstuffs, intermediate words B1 include a word indicating the name of a foodstuff, such as komatsuna. Meanwhile, if attribute D1 pertains to the cooking time, intermediate words B1 include a word, such as “time saving” (can be cooked quickly), that bears an association with the cooking time. In the description herein, the temperature information in attribute D1 is the temperature of the cooked menu item itself. Alternatively, this temperature information may be the outside temperature suitable for a given menu item to be cooked. For example, for the attribute the temperature of the menu item to be cooked a hot pot, an outside temperature condition where one feels cold from a sudden drop in the temperature can be set (e.g., the outside temperature is 13 degrees or lower and the temperature has dropped by 5 degrees or more within that day or from the previous day).

With the information presentation method according to the present embodiment, a plurality of intermediate words B1 are presented upon being determined based on condition information C1 associated with user 5 (see FIG. 1). Therefore, user 5 can be presented with presentation information A1 only by selecting intermediate word B1 that user 5 finds of interest from the plurality of intermediate words B1. In other words, unlike the technique disclosed in PTL 1, the information presentation method according to the present embodiment saves user 5 from thinking of and inputting a search word that works like intermediate word B1. As a result, the present embodiment provides advantageous effects of improving the user-friendliness for user 5 and allowing the intention of user 5 to be reflected more readily.

Information presentation system 100 according to another implementation of the embodiment presents a user with an item of presentation information A1 selected from items of presentation information A1.

As illustrated in FIG. 1, information presentation system 100 includes first determiner 11, first presenter 13, second determiner 12, and second presenter 14.

First determiner 11 determines a plurality of intermediate words B1 based on condition information C1. First presenter 13 presents user 5 with the plurality of intermediate words B1 such that user 5 can select one or more intermediate words B1 from the plurality of intermediate words B1. Second determiner 12 determines, of the items of presentation information A1, an item of presentation information A1 that corresponds to one or more intermediate words B1 selected by user 5. Second presenter 14 presents user 5 with the determined item of presentation information A1.

This information presentation system 100 also provides advantageous effects of improving the user-friendliness for user 5 and allowing the intention of user 5 to be reflected more readily.

It is to be noted that, according to the present embodiment, all the functions of first determiner 11, first presenter 13, second determiner 12, and second presenter 14 are integrated and incorporated into server 1 that can communicate with one or more presentation devices 2. Alternatively, at least one of these functions may be incorporated into a device other than server 1. An assumption herein is that server 1 is constituted by a single server device. Alternatively, server 1 may be constituted by a plurality of server devices, and such server devices may construct, for example, a cloud (cloud computing).

Information presentation system 100 according to the present embodiment, for example, manages history information pertaining to intermediate words B1 or the like that user 5 selects on a daily basis and, through machine learning, determines a plurality of intermediate words B1 that are more suitable for the lifestyle pattern (the lifestyle, the rhythm of life) and the preferences of user 5.

### (2) Details

Hereinafter, a configuration of information presentation system 100 according to the present embodiment will be described in detail with reference to FIG. 1 to FIG. 5.

### (2.1) General Configuration

Information presentation system 100 is configured to present user 5 with an item of presentation information A1 selected from items of presentation information A1. In this example, information presentation system 100 is configured to execute a presentation process of presenting a menu in response to a request from user 5. Information presentation system 100 includes one or more presentation devices 2 and server 1. In this example, as described above, a focus is on a plurality of users 5 (a family) living in home 200, and information presentation system 100 further includes microwave oven device 4 and router 6 that is provided in the house. Microwave oven device 4 is one of the electric home cooking appliances provided in the house. Herein, it is not a limitation that information presentation system 100 is applied to a family living in home 200, and information presentation system 100 may be applied to any user who needs the service of being provided with meal information (presentation information A1) pertaining to a meal.

In this example, the family living in home 200 includes four users 5: mother 50, father 53, child 51, and grandfather 52. In one example, mother 50 cooks daily meals for the entire family. Therefore, mainly mother 50 (cook X1) is the one who wants assistance with daily menu planning (wants presentation information A1 to be provided) from information presentation system 100. It is needless to say that a family member (e.g., father 53) other than mother 50 may temporarily serve as substituting cook X1.

As illustrated in FIG. 1, according to the present embodiment, each of the family members (the plurality of users 5) owns (carries) one presentation device 2. Mother 50 owns presentation device 2A, child 51 owns presentation device 2B, grandfather 52 owns presentation device 2C, and father 53 owns presentation device 2D.

As described above, in one example assumed herein, each presentation device 2 is a portable information terminal, such as a smartphone. Each presentation device 2 is connected to and can communicate with router 6 provided in the house, when user 5 carrying his or her presentation device 2 is at home 200. Each presentation device 2 wirelessly communicates with router 6 through wireless communication compliant with a standard, such as Wi-Fi (registered trademark), for example. Router 6 may also be connected to and can communicate with various other electronic devices in the house. According to the present embodiment, microwave oven device 4 corresponds to one of the electronic devices that can communicate with router 6. Then, each presentation device 2 can wirelessly communicate with microwave oven device 4 via router 6. Other electronic devices that can communicate with router 6 include, for example but not limited to, home appliances, such as a freezer refrigerator, an oven, or a rice cooker, as well as other cooking appliances. If home 200 is equipped with a home energy management system (HEMS), a controller for the HEMS is also connected to and can communicate with router 6. Router 6 is connected to network NT1, such as the internet (see FIG. 1). Each presentation device 2 and the various other electronic devices can communicate with server 1 external to home 200 via router 6. Server 1 will be described in further detail in the next section.

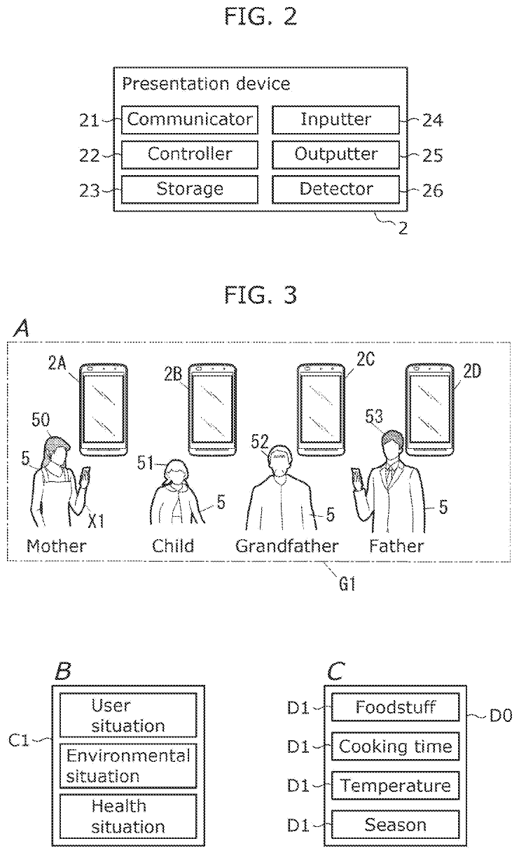

As illustrated in FIG. 2, each presentation device 2 includes communicator 21, controller 22, storage 23, inputter 24, outputter 25, and detector 26. Each presentation device 2 has preinstalled therein application software dedicated to presenting a graphical user interface (GUI) pertaining to a meal by communicating with microwave oven device 4, server 1, and so on. Hereinafter, this application software may be called simply as a cooking app.

Communicator 21 is a communication interface for communicating with microwave oven device 4, server 1, and so on. Each presentation device 2 transmits or receives data to or from microwave oven device 4, server 1, and so on via communicator 21.

Controller 22 is configured to control corresponding presentation device 2 as a whole. More specifically, controller 22 is configured to control communicator 21, controller 22, storage 23, inputter 24, outputter 25, and detector 26. For example, controller 22 may be implemented by a computer system that includes one or more processors (microprocessors) and one or more memories. In other words, the computer system functions as controller 22 as the one or more processors execute one or more programs (applications) stored in the one or more memories. A program herein is recorded in advance in a memory of controller 22. Alternatively, a program may be provided via an electrical communication circuit, such as the internet, or provided with the program recorded in a non-transitory recording medium, such as a memory card.

Storage 23 is constituted by a readable and writable memory. Storage 23 is, for example, a flash memory. Storage 23 is provided external to controller 22. Alternatively, storage 23 may be provided internal to controller 22. In other words, storage 23 may be a built-in memory in controller 22. Storage 23 stores various items of data.

Inputter 24 is a user interface that receives an input operation from user 5. In this example, a touch panel display (display 25A) provided in presentation device 2 functions as inputter 24 as well. In other words, presentation device 2 receives a user input as user 5 operates (e.g., taps) display screen 250 of display 25A with his or her finger tip or the like. Moreover, a microphone provided in presentation device 2 may also function as inputter 24 (voice input). Inputter 24 receives a user input pertaining to the cooking app. In particular, inputter 24 receives an input for selecting intermediate word B1 or presentation information A1 that user 5 finds of interest, respectively, from a presented plurality of intermediate words B1 described above or from presented items of presentation information A1 described above.

Outputter 25 is a user interface that outputs (presents) various items of information to user 5. In this example, touch panel display 25A provided in presentation device 2 functions as outputter 25. Moreover, a speaker provided in presentation device 2 may also function as outputter 25. Outputter 25 outputs information pertaining to the cooking app to user 5. In particular, outputter 25 executes the presenting, for example but not limited to, by outputting, via display 25A, a tag (an object image) containing intermediate word B1 and image data or character string data pertaining to presentation information A1 or by outputting, via the speaker, audio data pertaining to intermediate word B1 or presentation information A1.

Detector 26 is configured to detect the user situation of user 5 carrying the host device (presentation device 2). For example, detector 26 obtains the current position information of the host device by use of a satellite positioning system, such as a global positioning system (GPS), and detects the current location (the user situation) of user 5 carrying presentation device 2 based on the obtained position information. Controller 22 transmits the information pertaining to the current location of user 5 detected by detector 26 to server 1 via communicator 21. The user situation that detector 26 detects is not limited to the current location (the coordinates) of user 5. Detector 26 has a function of a hygrothermometer. Thus, detector 26 detects the temperature of its surroundings and transmits information pertaining to the temperature (the environmental situation) to server 1 via communicator 21.

Detector 26 may have a function of a pedometer, and the user situation may be the number of steps that user 5 has taken, the calories consumed by user 5, the duration that user 5 has walked, the walking speed of user 5, or the like. Moreover, detector 26 may have a function of extracting a feature amount from an object in an image captured by an imager (a camera) provided in presentation device 2, and the user situation may be the feature amount obtained from the image.

It is not a limitation that the functions of detector 26 are provided in presentation device 2, and these functions may be provided in an external device of presentation device 2. In this case, it is preferable that the external device can communicate with presentation device 2 or server 1 via router 6. For example, a blood pressure monitor provided in the house may detect the blood pressure level of user 5 (the user situation) and transmit this detection result to presentation device 2 or server 1.

User 5 starts the cooking app in presentation device 2 and inputs, in the login screen, a user ID and a password provided in advance from the provider of the cooking app. Thus, user 5 can receive various services pertaining to meal information associated with his or her user ID.

User 5 starts the cooking app at a desired timing in presentation device 2 and provides an input to receive a menu proposal. Then, presentation device 2 transmits a menu requesting signal including the user ID and so on to server 1. Triggered by receiving the menu requesting signal from presentation device 2, server 1 executes a menu proposing process that is adaptive for each individual and utilizes an artificial intelligence (AI) technology so that server 1 can propose a menu suitable for given user 5 with the received user ID.

### (2.2) Server

Server 1 is installed outside home 200. For example, server 1 may be operated by an entity (a provider) that provides user 5 with a service involving meal information (presentation information A1) pertaining to a meal. As described above, server 1 is constituted by a single server device, for example.

Server 1 collects various items of information from a plurality of users 5 who receive a service pertaining to presentation information A1 via presentation device 2 or the like and manages the collected information. The description herein focuses on a family (four users 5) in home 200, and server 1 manages personal information (the user ID, the name, the address, the telephone, the email address, and so on) of each of the four family members. Moreover, server 1 manages group information indicating that the four family members (the four user IDs) constitute one group G1 (see A in FIG. 3), identification information of each of four presentation devices 2 of the respective family members, and their respective user IDs and passwords. Furthermore, server 1 manages location information of home 200 and identification information and so on of electric home cooking appliances (microwave oven device 4) inside home 200.

The information pertaining to the family in home 200 described above is managed by server 1 in the form of user data M3 (see FIG. 1). In this example, server 1 also provides a service of providing presentation information A1 to other users 5 other than the family living at home 200 (e.g., to users in other households). Thus, server 1 also collects information on other users 5 and manages the collected information as user data M3.

As illustrated in FIG. 1, server 1 includes communicator 10, processor P1, and storage 17.

Communicator 10 is a communication interface for communicating bidirectionally with presentation device 2 of each user 5 and an electric home cooking appliance, such as microwave oven device 4, via network NT1.

Storage 17 is constituted by a readable and writable memory. Storage 17 is, for example, a flash memory. Storage 17 is provided external to processor P1. Alternatively, storage 17 may be provided internal to processor P1. In other words, storage 17 may be a built-in memory in processor P1. Storage 17 stores various items of data. In particular, as illustrated in FIG. 1, storage 17 stores (holds) context data M1, food and drink data M2, and user data M3.

Processor P1 is configured to perform a general controlling process of server 1. For example, processor P1 may be implemented by a computer system that includes one or more processors (microprocessors) and one or more memories. In other words, the computer system functions as processor P1 as the one or more processors execute one or more programs (applications) stored in the one or more memories. A program herein is recorded in advance in a memory of processor P1. Alternatively, a program may be provided via an electrical communication circuit, such as the internet, or provided with the program recorded in a non-transitory recording medium, such as a memory card.

In this example, as illustrated in FIG. 1, processor P1 includes first determiner 11 and second determiner 12. In other words, processor P1 has a function of first determiner 11 and a function of second determiner 12. Moreover, as illustrated in FIG. 1, processor P1 further includes first presenter 13, second presenter 14, third presenter 15, and setter 16. In other words, processor P1 has a function of first presenter 13, a function of second presenter 14, a function of third presenter 15, and a function of setter 16.

First determiner 11 is configured to determine a plurality of intermediate words B1 based on condition information C1 associated with user 5 (first determining step). In response to receiving a menu requesting signal from presentation device 2, first determiner 11 determines a plurality of intermediate words B1 based on the user ID included in the menu requesting signal.

Now, intermediate word B1 will be described. Intermediate word B1 is a word that bears an association with attribute D1 (see FIG. 3) pertaining to one or more items of presentation information A1 among multiple items of presentation information A1. C in FIG. 3 is a conceptual diagram representing attribute group D0 that includes a plurality of attributes D1. Master information of each item of presentation information A1 in server 1 is stored in food and drink data M2 in storage 17 with the master information associated with information pertaining to a plurality of attributes D1 in attribute group D0.

Specifically, for example, master information of a menu item to be cooked a chowder (presentation information A1) is associated with such items of information as tofu, napa cabbage, salmon, carrot, and konnyaku noodles pertaining to attribute D1 of foodstuffs. Moreover, the master information of the chowder is associated with information indicating, for example, 40 minutes as attribute D1 pertaining to the cooking time. Furthermore, the master information of the chowder is associated with information indicating, for example, 80 degrees as attribute D1 pertaining to the temperature. Furthermore, the master information of the chowder is associated with information indicating, for example, winter as attribute D1 pertaining to the season. Then, with regard to the chowder, intermediate words B1 therefore include a word that bears an association with the foodstuffs for the chowder (tofu, napa cabbage, salmon, carrot, and konnyaku noodles), the cooking time (40 minutes), the temperature (80 degrees), and the season (winter). Intermediate word B1 may be a word that includes the name of the foodstuff itself, a word such as “time saving” that bears an association with the cooking time (40 minutes), or a word such as “warming” or “hot pot” (of the season) that bears an association with the temperature (80 degrees) or the season (winter). As a result, the menu item to be cooked the chowder is associated with a plurality of intermediate words B1, including “tofu”, “time saving”, “warming”, and “hot pot”.

Server 1 analyzes data obtained from an external server or data pertaining to a meal submitted from an individual and periodically updates information pertaining to, for example but not limited to, the type of attribute D1, the specific cooking time, and the temperature.

Next, condition information C1 will be described. Condition information C1 is obtained information obtained in advance automatically and in real time from presentation device 2 or the like of user 5. In other words, condition information C1 is information that user 5 does not need to input himself or herself when user 5 requests a menu proposal. However, condition information C1 may in part include information that user 5 himself or herself inputs as needed. For example, in a case where user 5 wants to limit the number of intermediate words B1 to be presented with (e.g., no more than five intermediate words B1, etc.), user 5 may input information specifying the number of intermediate words as condition information C1 as needed.

As illustrated in B in FIG. 3 and shown in Table 1 below, condition information C1 includes information pertaining to a situation (a context) such as the user situation, the stocking situation, or the environmental situation. In other words, condition information C1 is information that pertains to user 5 and can change on a daily basis.

TABLE 1

| | Obtained | Context | Intermediate |
|---|---|---|---|
| | Information | Condition | Word Example |
| User | Time | After 19:00 | Time saving |
| Situation | Information | Weekends and | Eat out |
| | | holidays | Home meal |
| | | | replacement |
| | Location | Outside home | Eat out |
| | Information | Five km or more | Home meal |
| | | away from home | replacement |
| | | Moving | Soothing |
| | Health | Higher than | Weight |
| | Information | standard BMI | watching |
| | | Higher than | Blood sugar |
| | | standard blood | level |
| | | sugar level | Low calories |
| Stocking | Stock | There is a | Name of stocked |
| Situation | Information | foodstuff with an | foodstuff |
| | | expiration date of | (example: |
| | | one day or less | komatsuna) |
| Environmental | Temperature | Lower than the | Warming |
| Situation | Information | previous day's | Hot pot |
| | | temperature by | |
| | | four degrees or | |
| | | more | |

### [User Situation]

As shown in Table 1, for example, the user situation may include, for example but not limited to, the time information, the location information, and the health information. The context conditions and the intermediate word examples shown in Table 1 are merely examples and are not limited to those shown above. Information presentation system 100 may change intermediate words B1 that correspond to the condition examples on a daily basis based on the items (history information) selected by user 5 so that intermediate words B1 better match the individual preferences and so on. The history information will be described in further detail in the next section.

The time information is information pertaining to the timing at which user 5 requests a menu proposal, and the time information is transmitted from presentation device 2 with the time information included in a menu requesting signal. In this example, the time information includes information indicating the year, the month, the day of the month, the time of the day, and the day of the week. Alternatively, the time information may include information indicating only the time of the day, for example. Moreover, the time information may be information that is based on the duration measured by a timer in server 1 or information pertaining to the timing at which a menu requesting signal has been received. Then, the time information is used to determine whether a predetermined context condition is satisfied. As shown in Table 1, some examples of the predetermined context condition with respect to the time information include after 19:00 and weekends and holidays. First determiner 11 may determine a word such as “time saving”, “eat out”, or “home meal replacement” as intermediate word B1 if the time information satisfies at least one of the context condition after 19:00 or the context condition weekdays and holidays.

The location information is information pertaining to the current location (position) of user 5. In this example, the location information is information pertaining to the current location of user 5 detected by detector 26. The location information of user 5 who has requested a menu proposal is transmitted from presentation device 2 with the location information included in a menu requesting signal. The location information is not limited to the current location of user 5 who has requested a menu proposal, and information pertaining to the current locations of other users 5 in the family is also transmitted from presentation devices 2 of other respective users 5. For example, server 1 transmits a signal requesting that the location information be transmitted to server 1 to presentation devices 2 of other respective users 5 in the family at a timing at which server 1 has received a menu requesting signal. Then, the location information is used to determine whether a predetermined context condition is satisfied. As shown in Table 1, some examples of the predetermined context condition with respect to the location information include outside home, five km or more away from home, and moving (e.g., on the way home). First determiner 11 may determine a word such as “eat out”, “home meal replacement”, or “soothing” as intermediate word B1 if the location information satisfies at least one of the context condition outside home, the context condition five km or more away from home, or the context condition moving.

The health information is information pertaining to the current state of health of user 5 and is managed in advance in server 1, for example. User 5 can, for example, start the cooking app in presentation device 2 and register, change, or delete the health information at a desired timing. The health information includes, for example but not limited to, the age, the height, the body weight, the vision, the hearing acuity, the blood pressure, the blood sugar level, or the name of any chronic illness, and these items of information are transmitted from presentation device 2 to server 1. One or more items of health information may be transmitted directly from an external device (e.g., a blood pressure monitor) to server 1, as described above. Server 1 stores these items of information into storage 17 as user data M3 and manages user data M3. It is needless to say that these pieces of information pertaining to the state of health do not have to be input if user 5 desires not to register them. Then, the health information is used to determine whether a predetermined context condition is satisfied. As shown in Table 1, some examples of the predetermined context condition with respect to the health information include higher than standard BMI (body mass index) and higher than standard blood sugar level. First determiner 11 may determine a word such as “weight watching”, “blood sugar level”, or “low calories” as intermediate word B1 if the health information satisfies at least one of the context condition higher than standard BMI or the context condition higher than standard blood sugar level.

### [Stocking Situation]

As shown in Table 1, for example, the stocking situation may include stock information pertaining to foodstuffs. In other words, the stock information is information indicating foodstuffs that user 5 has purchased (or received from others) and stores in the refrigerator or the like at home 200. In this example, the stock information is information pertaining to, for example but not limited to, the name of a foodstuff, its type (a category such as meat, seafood, beans, grains, fresh vegetables, fresh fruits, or mushrooms), the storage location, the remaining amount (the number of pieces, the weight, or the like), the date of purchase, and the manage-by date. The manage-by date is assumed to be, for example but not limited to, the expiration date or the best-before date. Alternatively, the manage-by date may be the date set by user 5 as desired (e.g., the date set to precede the expiration date). User 5 can, for example, start the cooking app in presentation device 2 and register, change, or delete the stock information at a desired timing. These items of information are transmitted from presentation device 2 to server 1. Server 1 stores these items of information into storage 17 as user data M3 and manages user data M3. It is needless to say that these pieces of stock information do not have to be input if user 5 desires not to register them. Moreover, in a case where a one-dimensional code or a two-dimensional code is provided on a packaging material for a purchased foodstuff, presentation device 2 may read the code with the imager of presentation device 2 and transmit the stock information including, for example, the expiration date to server 1.

Server 1 manages the stock information of foodstuffs that user 5 stores. When user 5 inputs, into presentation device 2, information indicating that user 5 actually wants to cook the dish indicated by presentation information A1 proposed by information presentation system 100, presentation device 2 transmits a feedback signal including such information to server 1. Moreover, in a case where user 5 has cooked a dish by use of microwave oven device 4, microwave oven device 4 transmits a feedback signal including information on the menu item cooked to server 1. Server 1 estimates the type and the amount (the number of pieces, the weight, or the like) of the foodstuffs used based on a feedback signal and updates the stock information for user data M3 (reduces the stock by the amount used). It is needless to say that the stock information for user data M3 may be updated as presentation device 2 directly receives an input of information indicating the amount of foodstuffs that user 5 has actually used.

Then, the stock information is used to determine whether a predetermined context condition is satisfied. As shown in Table 1, some examples of the predetermined context condition with respect to the stock information include there is a foodstuff with an expiration date of one day or less. First determiner 11 may determine a word such as “komatsuna expires” that includes the name of the foodstuff as intermediate word B1 if the stock information includes a foodstuff that satisfies the context condition there is a foodstuff with an expiration date of one day or less. In other words, “komatsuna expires” is intermediate word B1 that corresponds to the fact that the expiration date of komatsuna that user 5 currently stores comes in one day or less.

In this manner, first determiner 11 includes a function of determining intermediate word B1 based on the manage-by date pertaining to a foodstuff. In other words, the first determining step includes determining intermediate word B1 based on the manage-by date pertaining to a foodstuff.

### [Environmental Situation]

As shown in Table 1, for example, the environmental situation may include temperature information. The temperature information is information on the temperature in the area (e.g., AA city) where home 200 that user 5 lives in is located. Server 1 identifies the temperature information of the area where home 200 is located based on the location information of home 200 stored in storage 17. For example, server 1 obtains, from an external server (a server that manages the meteorological data), the temperature information of the AA city indicating the temperature held at the time of receiving a menu requesting signal. The temperature information does not have to be the temperature information of the area where home 200 is located and may be temperature information of the current location of user 5 detected by detector 26. Then, the temperature information is used to determine whether a predetermined context condition is satisfied. As shown in Table 1, some examples of the predetermined context condition with respect to the temperature information include lower than the previous day's temperature by four degrees or more. First determiner 11 may determine a word such as “warming” or “hot pot” as intermediate word B1 if the temperature information satisfies this context condition.

According to the present embodiment, the master information pertaining to the context conditions and the intermediate word examples described above are stored in storage 17 as context data M1, as illustrated in FIG. 1. The context conditions and the intermediate word examples are stored in many-to-many associations. For context data M1, server 1 analyzes the data obtained from an external server or the data submitted by individuals, collects the latest words (popular expressions or the like), and updates context data M1 on a daily basis (enhancement of context data M1).

First presenter 13 is configured to present user 5 with a plurality of intermediate words B1 such that user 5 can select one or more intermediate words B1 from the plurality of intermediate words B1 (first presenting step). Specifically, first presenter 13 generates a signal (a context selecting signal) that includes information pertaining to a plurality of intermediate words B1 determined by first determiner 11 and transmits, via communicator 10, the generated signal to presentation device 2 that has transmitted the menu requesting signal. For example, in a case where mother 50 has transmitted a menu requesting signal from presentation device 2A, first presenter 13 transmits a context selecting signal to presentation device 2A and causes the context selecting signal to be output from outputter 25 of presentation device 2A. In other words, in one example, mother 50 owning presentation device 2A is given the authority to select one or more intermediate words B1 from a plurality of intermediate words B1.

In response to communicator 21 of each presentation device 2 (in this example, presentation device 2A of mother 50) receiving a context selecting signal, controller 22 displays each of the plurality of intermediate words B1 on display screen 250 of display 25A functioning as outputter 25, as illustrated in FIG. 4. In the example illustrated in FIG. 4, three intermediate words B1 “time saving”, “soothing”, and “komatsuna expires” are presented. In the example illustrated in FIG. 4, three intermediate words B1 are displayed with each intermediate word B1 contained in a circular or elliptic tag. First tag B11 shows intermediate word B1 “time saving”. Second tag B12 shows intermediate word B1 “komatsuna expires”. Third tag B13 shows intermediate word B1 “soothing”. First tag B11 to third tag B13 can each be tapped by user 5 with his or her finger tip or the like, and then its corresponding intermediate word B1 can be selected.

It is preferable that presentation device 2 output, via outputter 25, a message (character string data or audio data) prompting user to select one or more intermediate words B1 from three intermediate words B1.

First tag B11 to third tag B13 have mutually different region sizes in which first tag B11 to third tag B13 respectively are displayed on display screen 250. In the example illustrated in FIG. 4, second tag B12 has the largest region size, first tag B11 has the second largest region size, and third tag B13 has the smallest region size. Information presentation system 100 according to the present embodiment sets a larger region size for intermediate word B1 that is estimated to be of a greater interest to user 5 who has transmitted the menu requesting signal.

Specifically, first determiner 11 determines an index called the recommendability for each of the determined plurality of intermediate words B1, and first presenter 13 transmits the result pertaining to this index with this result included in a context selecting signal. The recommendability may be an absolute index for each intermediate word B1 or a relative index among the plurality of intermediate words B1. The recommendability is determined relative to each other, for example, based on the degree to which condition information C1 of user 5 matches the context condition and the history information indicating the past selection of user 5 in user data M3 stored in storage 17. In a case where user 5 has limited the number of intermediate words B1 to be presented to five, for example, if there are six or more corresponding intermediate words B1, first presenter presents only five intermediate words B1 of the top recommendability.

Controller 22 of presentation device 2 determines the region size of each tag based on the recommendability included in a context selecting signal and displays intermediate words B1 on display screen 250. It is not a requirement that the region size of the tag be changed in accordance with the recommendability, and first tag B11 to third tag B13 may all have the same region size.

When user 5 finds intermediate word B1 that is of high interest to user 5 among the plurality of intermediate words B1 displayed on display screen 250, user 5 taps the tag corresponding to that intermediate word B1 with his or her finger tip or the like. In the example illustrated in FIG. 4, first tag B11 and second tag B12 have been tapped and selected (see the dot hatching in presentation device 2 depicted in the center in FIG. 4). Alternatively, only one of the tags may be selected, or all the tags may be selected. If user 5 is unable to find any word that is of interest to user 5 among the plurality of intermediate words B1 displayed on display screen 250, user 5 taps an object region (not illustrated in FIG. 4) for requesting that different intermediate words be presented (a request for re-presentation). Then, information presentation system 100 receives the request for re-presentation. When server 1 has received a signal pertaining to the request for re-presentation from presentation device 2, first determiner 11 extracts intermediate word B1 different from any of the plurality of intermediate words B1 presented previously.

In response to user 5 selecting one or more intermediate words B1 from a plurality of intermediate words B1, controller 22 of presentation device 2 generates a signal (a food and drink requesting signal) indicating selected intermediate word B1 and transmits the generated signal to server 1 via communicator 21. In response to receiving the food and drink requesting signal, server 1 determines presentation information A1 via second determiner 12, which will be described later. Processor P1 stores the selection result of user 5 (including the request for re-presentation), that is, stores intermediate word B1 that has been of interest to user 5 (that user 5 has selected) and intermediate word B1 that was not of interest to user 5 (that user 5 did not select) into storage 17 as history information (user data M3). Then, processor P1 reflects this selection result of user 5 in determining intermediate words B1 in subsequent instances.

Second determiner 12 is configured to determine, of items of presentation information A1, an item of presentation information A1 that corresponds to one or more intermediate words B1 selected by user 5 (second determining step). Specifically, in response to receiving a food and drink requesting signal indicating intermediate word B1 selected by the user from presentation device 2 via communicator 10, second determiner 12 refers to the master information termed food and drink data M2 in storage 17 and extracts presentation information A1 corresponding to selected intermediate word B1. As shown in Table 2 below, food and drink data M2 is stored in storage 17 with the name of a menu item to be cooked and corresponding intermediate word B1 associated with each other in many-to-many associations. Moreover, in food and drink data M2, the name of each menu item is stored with the name associated with the necessary ingredients including their amounts. Although the description is omitted herein, the name of each menu item is stored with the name associated with its recipe (how to cook that menu item) as well in food and drink data M2. In other words, meal information according to the present embodiment includes information pertaining to a menu item to be cooked. Food and drink data M2 is also associated with an electric home cooking appliance necessary for cooking each menu item, and one of such electric home cooking appliances corresponds to microwave oven device 4, for example. In this example, microwave oven device 4 also manages information pertaining to food and drink data M2, and if user 5 cooks a give menu item by use of microwave oven device 4, this information is transmitted directly from microwave oven device 4 to server 1.

TABLE 2

| Name of | | Intermediate |
|---|---|---|
| Menu Item | Ingredients: Amounts | Word Example |
| Chowder | Napa cabbage: ½ | Warming |
| | Tofu: 1 block | Hot pot |
| | Salmon: 2 pieces | |
| | Carrot: 1 | |
| | Konnyaku noodles: 1 | |
| | package | |
| Seasoned Boiled | Komatsuna: 1 bunch | Time saving |
| Komatsuna | Stock: ⅓ teaspoons | Komatsuna |
| (for two persons) | Soy sauce: 2 teaspoons | expires |
| | Mirin: 1 tablespoon | |
| | Dried bonito flakes: | |
| | Small amount | |

Second determiner 12 extracts, from food and drink data M2 stored in storage 17, presentation information A1 (a menu) including the name of the menu item that corresponds to one or more intermediate words B1 selected by user 5. In this example, in response to user 5 selecting two intermediate words B1 “time saving” and “komatsuna expires” in presentation device 2, the name or names of one or more menu items associated with both of these two intermediate words B1 may be selected.

Specifically, intermediate word B1 “time saving” is associated with, in addition to the seasoned boiled komatsuna, other menu items to be cooked such as a salmon rice porridge, an egg omelet sandwich, and a chicken and egg rice bowl as well in food and drink data M2. Meanwhile, intermediate word B1 “komatsuna expires” is associated with other menu items to be cooked such as garlic sauteed komatsuna as well, in addition to the seasoned boiled komatsuna, in food and drink data M2. In this case, second determiner 12 selects the seasoned boiled komatsuna associated with both “time saving” and “komatsuna expires”. In this manner, second determiner 12 includes a function of determining a menu item to be cooked based on the manage-by date of a foodstuff. In other words, the second determining step includes determining presentation information A1 based on the manage-by date of a foodstuff.

In a similar manner, in the example shown in Table 2, if user 5 selects two intermediate words B1 “warming” and “hot pot” in presentation device 2, the name of a menu item associated with both of these two intermediate words B1 (e.g., a chowder) may be selected.

Second presenter 14 is configured to present user 5 with determined presentation information A1 (second presenting step). Specifically, second presenter 14 generates a signal (a menu presenting signal) that includes information pertaining to one or more items of presentation information A1 determined by second determiner 12 (in this example, the name of the menu item called seasoned boiled komatsuna, the necessary ingredients, the recipe, an image of the menu item to be cooked, and the like). Then, second presenter 14 transmits, via communicator 10, the menu presenting signal to presentation device 2 that has transmitted the food and drink requesting signal. For example, in a case where mother 50 has transmitted a food and drink requesting signal from presentation device 2A, second presenter 14 transmits a menu presenting signal to presentation device 2A and causes the menu presenting signal to be output from outputter 25 of presentation device 2A. The image of a menu item to be cooked may be an image prepared in advance by the provider operating server 1 or an original image of the menu item that an individual has submitted to server 1.

When communicator 21 of each presentation device 2 (in this example, presentation device 2A of mother 50) has received a menu presenting signal, controller 22 displays presentation information A1 on display screen 250 of display 25A, as shown in presentation device 2 illustrated in the right side in FIG. 4. In the example illustrated in FIG. 4, information pertaining to the name of the menu item the seasoned boiled komatsuna (character string data), an image of that menu item (image data), and the necessary ingredients (character string data) is displayed on the screen as presentation information A1. In this example, tapping the display field displaying the necessary ingredients takes the user to a screen that displays more detailed information (e.g., the recipe). In the example illustrated in FIG. 4, only one item of presentation information A1 (one item called the seasoned boiled komatsuna) is presented. Alternatively, two or more items of presentation information A1 may be presented. Moreover, presentation information A1 may further include information indicating the salt content, the calories, and the nutritional content of that menu item to be cooked as well as any electric home cooking appliance to be used (e.g., microwave oven device 4).

Information presentation system 100 according to the present embodiment receives selection of presentation information A1 as, for example, user 5 taps display screen 250 within a predetermined region displaying one or more items of presentation information A1 with his or her finger tip or the like. In other words, if user 5 finds a menu item that is of interest to user 5 among one or more presented menu items (e.g., a menu item that makes user 5 want to cook that item), user 5 selects that menu item. With this selection, information presentation system 100 receives an indication that user 5 is going to cook that menu item (the final selection on presentation information A1).

Presentation device 2 transmits a signal (a feedback signal) including the selection result to server 1. In response to receiving the feedback signal from presentation device 2 via communicator 10, processor P1 of server 1 assumes that user 5 has actually cooked that menu item based on the selection result. Then, processor P1 estimates the type and the amount (the number of pieces, the weight, and so on) of the foodstuffs that may have been used for that menu item and updates the stock information in user data M3 (reduces the stock by the amount to be used). Moreover, processor P1 stores the selection result of user 5, that is, stores presentation information A1 that has been of interest to user 5 (that user 5 has selected) and presentation information A1 that was not of interest to user 5 (that user 5 did not select) into storage 17 as history information (user data M3). In other words, as with the selection result concerning intermediate words B1, processor P1 reflects the selection result on presentation information A1 as well in determining intermediate words B1 in subsequent instances.

It is preferable that the authority to make the final selection on presentation information A1 be given only to cook X1 (e.g., mother 50) who actually performs the cooking. Therefore, in information presentation system 100, a cook flag indicating that a given user is cook X1 can be set to a user ID in user data M3 stored in storage 17. Processor P1 of server 1 determines whether a cook flag is given to the user ID of the user who has transmitted a feedback signal and assumes that user 5 has actually cooked that menu item if this user 5 is given the cook flag. If a feedback signal has been transmitted from a user ID that is not given a cook flag, server 1 notifies presentation device 2 to that effect.

Third presenter 15 is configured to present how a specific foodstuff is to be stored if user 5 indicates an action negating the consumption of the specific foodstuff (third presenting step). For example, in the example described above, the assumption is that the expiration date of komatsuna among the foodstuffs stored by user 5 is within one day or less and that first presenter 13 has presented intermediate word B1 “komatsuna expires” among a plurality of intermediate words Bl. However, if user 5 refrains from selecting “komatsuna expires” and has selected another intermediate word B1 instead, this increases the likelihood that second presenter 14 presents a menu item to be cooked (presentation information A1) that does not use komatsuna. As a result, although the expiration date of komatsuna is nearing, it is highly likely that cook X1 (e.g., mother 50) selects a menu item to be cooked that does not use komatsuna as the final selection.

Moreover, if user 5 has selected intermediate word B1 such as “eat out” or “home meal replacement”, it becomes highly likely that user 5 eats out or purchases a ready-cooked dish (a ready-prepared dish or the like) although the expiration date of komatsuna is nearing. As a result, although the expiration date of komatsuna is nearing, it becomes highly likely that the user takes an action (eating out, having a home meal replacement) that negates the consumption of komatsuna.

Third presenter 15 presents how to store a foodstuff (a specific foodstuff) that is in such a state. Specifically, third presenter 15 presents, to presentation device 2 of user 5, information indicating that komatsuna nearing its expiration date can be washed, cut into thin pieces, and stored in a freezer, for example. There is no particular limitation on the timing at which information on how to store a foodstuff is presented. For example, such information is presented after user 5 has made the final selection on presentation information A1. Information pertaining to how to store a foodstuff is stored in storage 17 as food and drink data M2 with the information associated with each foodstuff. Information presentation system 100 also prompts the user to store komatsuna by presenting how to store komatsuna. In this example, information presentation system 100 may merely prompt the user to store a foodstuff without presenting how to store the foodstuff (may output a message prompting the user to store a foodstuff). Moreover, some foodstuffs may not be suitable for storage depending on the type of the foodstuffs (e.g., eggs, dairy products, or the like). Therefore, if information presentation system 100 has determined that the expiration date of such a foodstuff is highly likely to pass, information presentation system 100 may output a message prompting the user to discard that foodstuff.

In this manner, third presenter 15 presents how to store a foodstuff when user 5 takes an action that negates the consumption of that foodstuff, and thus the user-friendliness can be improved.

Setter 16 is configured to set group G1 (see A in FIG. 3) that includes a plurality of users 5 (setting step). Presentation device 2 can receive, via the cooking app, an operation input for associating the family of users 5 (mother 50, father 53, child 51, and grandfather 52) as one group G1. In response to receiving the operation input pertaining to the group setting, presentation device 2 transmits information pertaining to this group setting to server 1. In response to receiving this information pertaining to the group setting from presentation device 2, setter 16 stores this group setting into storage 17 as user data M3. Group G1 is associated by the user IDs of the subjects.

According to the present embodiment, in response to receiving a menu requesting signal from presentation device 2 of user 5 for which a group is set, at least one of first presenter 13 or second presenter 14 can perform the presenting in the unit of group G1. In other words, at least one step of the first presenting step or the second presenting step includes presenting information in the unit of group G1. In this manner, information presentation system 100 can present information in the unit of group G1, and thus information oriented for the plurality of users 5 (e.g., for the family) can be presented with ease.

In this example, setter 16 is configured to be capable of individually enabling or disabling the presentation of intermediate words B1 and the presentation of presentation information A1 in the unit of group G1. In one example case, the presentation of intermediate words B1 in the unit of group G1 is enabled, and the presentation of presentation information A1 in the unit of group G1 is disabled. When cook X1 (mother 50) performs an operation of transmitting a menu requesting signal from presentation device 2A, a plurality of intermediate words B1 are presented not only to presentation device 2A of mother 50 but also to presentation devices 2 of other family members (father 53, child 51, and grandfather 52). As a result, each of the family members can select intermediate word B1 that is of interest to him or her, and the opinions of all the family members can be more readily reflected into presentation information A1. At this point, first determiner 11 may determine a plurality of intermediate words B1 based on condition information C1 of all the family members or based on condition information C1 of one representative family member (e.g., cook X1). In this example, the presentation of presentation information A1 is disabled, and thus information is presented only to presentation device 2A of mother 50 serving as cook X1. It is needless to say that if the presentation of presentation information A1 in the unit of group G1 is enabled, presentation information A1 is presented not only to presentation device 2A of mother 50 but also to presentation devices 2 of the other family members.

However, even if the presentation of presentation information A1 in the unit of group G1 is enabled, as described above, it is preferable that the authority to make the final selection on presentation information A1 be given only to cook X1 (e.g., mother 50) who actually performs the cooking. In other words, it is preferable that the authority to select presentation information A1 presented at the second presenting step be given only to predetermined user 5 within group G1. In this case, the user-friendliness may be improved if the authority is given only to the person who executes a specific action (e.g., cook X1) based on presented presentation information A1 when group G1 includes both that person who executes the specific action and a person who does not execute that specific action.

### (2.3) Reflecting History Information

As described above, in information presentation system 100 according to the present embodiment, intermediate words B1 that correspond to the condition examples may be changed on a daily basis based on the items (history information) selected by user 5 so that intermediate words B1 better match the preferences and so on of each individual. The history information of user 5 also corresponds to one of the user situations described above. In other words, condition information C1 includes the history information. The history information includes a history pertaining to a plurality of intermediate words B1 presented previously to user 5 by first presenter 13 (at the first presenting step).

Moreover, according to the present embodiment, the history information includes a history pertaining to one or more intermediate words B1 that user 5 has selected previously. In other words, information presentation system 100 manages the history information pertaining to intermediate words B1 and so on that user 5 selects on a daily basis.

Furthermore, according to the present embodiment, the history information includes a history pertaining to an action taken by user 5 presented previously with presentation information A1 by second presenter 14 (at the second presenting step). Specifically, the history information may include a history pertaining to presentation information A1 that the user has selected as the final selection (or simply viewed without selecting) by tapping presentation device 2 as well as a history pertaining to presentation information A1 that the user did not select. Moreover, the history information may include a history indicating that the user has cooked a given menu item to be cooked (this menu item to be cooked does not necessarily match presentation information A1) by use of microwave oven device 4 as well as a history that is based on information obtained directly from microwave oven device 4. In other words, an action as mentioned above corresponds to selecting, viewing, or cooking (executing).

Moreover, the history information includes obtained information pertaining to the user situation, the stocking situation, and the environmental situation obtained previously. For example, the prior user situation may serve as a material for estimating the lifestyle pattern (the lifestyle, the rhythm of life) of given user 5.

Processor P1 of information presentation system 100 further includes learner 18 (see FIG. 1) that performs, for example, unsupervised learning based on the history information accumulated on a daily basis. Learner 18 performs clustering or the like by analyzing the structure and the feature of the history information and generates a model for each user 5 (or for each group G1). First determiner 11 determines a plurality of intermediate words B1 that are more suitable for the lifestyle pattern and the preferences of given user 5 with that model as well as the current situation (the context) held at the timing when a menu requesting signal has been received factored in. The history information accumulated on a daily basis as referred to herein may include not only the history information of user 5 himself or herself who has requested a menu proposal but also the history information of other users 5 within group G1 to which user 5 belongs and the history information of yet other users 5 other than users 5 living in home 200.

Some examples of the feature of the history information may include a feature where there is a strong tendency that a menu item with low calories or low salt content is selected as the user is watching his or her weight or blood pressure level, a feature where there is a strong tendency that the user makes do with a light supper, or a feature where there is a strong tendency that the user comes home late at or after 21:00. Moreover, for example, the examples of the features may include a feature where there is a strong tendency that the user prefers to cook a hot pot in the winter season, a feature where there is a strong tendency that the user is not very good at managing the manage-by date of foodstuffs and quite an amount of foodstuffs come close to their expiration dates, and a feature where the user often eats out on weekends and is less likely to cook himself or herself. With information presentation system 100, such features can be more readily reflected in determining intermediate words B1.

In this manner, according to the present embodiment, a plurality of intermediate words B1 are determined based on condition information C1 that includes the history information. Therefore, the lifestyle pattern, the preferences, and so on of user 5 are more readily reflected in a plurality of intermediate words B1, and as a result, presentation information A1 that better reflects the intention of user 5 is more likely to be presented.

In this example, it is preferable that at least one of first determiner 11 or second determiner 12 determine intermediate words B1 or presentation information A1 based on the manage-by date (of a foodstuff) and the lifestyle pattern of user 5. In other words, it is preferable that at least one step of the first determining step or the second determining step include making a determination based on the manage-by date and the lifestyle pattern of user 5. Specifically, for example, if given user 5 has a strong tendency of often eating out or having a home meal replacement and not cooking very often or if given user 5 has a strong tendency of coming home late, this increases the likelihood that foodstuffs reach their manage-by dates without being consumed. In other words, the frequency that user 5 cooks per week differs for different users 5. Accordingly, information presentation system 100 adjusts the timing of prompting user 5 to consume a foodstuff in accordance with the frequency that user 5 cooks (the lifestyle pattern of user 5) that is based on the history information of each user 5.

As described above, information presentation system 100 analyzes the lifestyle pattern of user 5 based on the history information. Information presentation system 100 presents user 5 who cooks relatively less frequently with intermediate words B1 and presentation information A1 pertaining to a foodstuff that is nearing its manage-by date with a sufficient time left till the manage-by date. For example, with regard to the condition that there is a foodstuff with an expiration date of one day or less, which is one of the context conditions shown in Table 1, if a different condition that there is a foodstuff with an expiration date of three days or less is applied to user 5 who cooks relatively less frequently, the timing at which intermediate word B1 pertaining to the manage-by date is presented can be moved up two days. This makes it possible to make a proposal pertaining to a meal that factors in the lifestyle pattern of user 5 as well as the manage-by date of a foodstuff.

### (2.4) Presentation of Foodstuff List

Some users 5 may, for example, determine am entire menu for the coming week to a certain extent and purchase foodstuffs in quantity to use for the menu for that week. Therefore, information presentation system 100 according to the present embodiment can specify the number of meals for which proposals are to be made. In other words, presentation information A1 is not limited to information pertaining to a single meal and may include information pertaining to two or more meals. A single meal as referred to herein, for example, is any one of a breakfast, a lunch, a supper, a snack between meals within a day. A single meal, however, may mean meals for a day. In one embodiment, the period (two days, one week, or the like) may be specified instead of specifying the number of meals, and for example, the period from March 1st to March 10th may be specified based on calendar information. The calendar information is stored in storage 17 along with event information and so on for each user 5 and managed along with user data M3. Each user 5 can browse his or her own calendar information via presentation device 2. For example, user 5 can browse the menu items cooked previously in the form of a calendar (the menu item cooked on February 1st: a chowder, etc.). User 5 can also register a planned event (e.g., a date planned for eat out, a date for a planned business trip of father 53, a date for a planned sports day of child 51, or the like) as schedule information. This schedule information also corresponds to one of the user situations in condition information C1 used when first determiner 11 determines intermediate words B1.

In response to receiving information specifying the number of meals for which the user wants a proposal from presentation device 2, second presenter 14 of server 1 presents presentation information A1 pertaining to a meal or meals corresponding to the specified number. In this example, second presenter 14 is configured to present, as presentation information A1, a collective list of foodstuffs corresponding to two or more meals (second presenting step).

For example, server 1 may receive a request for representation of presentation information A1 from user 5 one day or a few days after presenting presentation information A1 corresponding to a week's worth of meals. However, the situation (the context) of user 5 changes on a daily basis, and the stock of foodstuffs purchased in quantity for the week decreases as user 5 cooks on a daily basis. In this respect, information presentation system 100 according to the present embodiment is configured to update the list of foodstuffs (to be presented at once) in accordance with the change in condition information C1. Accordingly, in a case where condition information C1 may change on a daily basis, a list of foodstuffs that follows this change can be presented. In particular, information presentation system 100 can propose an optimal menu that can be prepared with the foodstuffs remaining at the time of receiving the request for representation of presentation information A1.

Moreover, it is preferable that the list of foodstuffs be updated in accordance with the selection result of user 5 made with respect to the previous presentation of presentation information A1. In this case, information presentation system 100 can present a list of foodstuffs that better reflects the lifestyle pattern, the preferences, and so on of user 5.

### (2.5) Priority

According to the present embodiment, priorities can be set for a plurality of user 5 in group G1. Then, in a case where the priorities are set, first determiner 11 is configured to determine a plurality of intermediate words B1 based on condition information C1 associated with user 5 of a higher priority in that group G1. In other words, priorities are set for a plurality of users 5 in group G1, and a plurality of intermediate words B1 are determined based on condition information C1 associated with user 5 of a higher priority at the first determining step.

The priorities among group G1 are set in the form of priority flags of 1 to 3, as shown in Table 3 below, for example.

TABLE 3

| First | Second | Family | Priority | Priority |
|---|---|---|---|---|
| Identifier | Identifier | Structure | Flag | Condition |
| #1 | #100 | Mother | 3 | |
| | #101 | Father | 3 | |
| | #102 | Child | 1 | Time to arrive |
| | | | | home |
| | #103 | Grandfather | 2 | Blood sugar |
| | | | | level |

In the example shown in Table 3, a set of a first identifier and a second identifier constitutes the user ID of each user 5. The first identifier is a unique ID for group G1, and the second identifier is a unique ID for distinguishing each family member within group G1. The priority flag of 1 corresponds to the highest priority, and the priority decreases in order from 2 to 3. In other words, in the example shown in Table 3, the highest priority is assigned to the user ID of child 51. Furthermore, information presentation system 100 according to the present embodiment can also set the priority condition. User 5 can input the priority flag and the priority condition by inputting them into presentation device 2.

For example, first determiner 11 determines intermediate words B1 based on condition information C1 associated with child 51 of the highest priority in group G1, that is, determines intermediate words B1 with the priority given to the lifestyle pattern and the preferences of child 51. In particular, since the priority condition of child 51 is set to the time to arrive home, first determiner 11 estimates the time when child 51 arrives home from the current location and incorporates intermediate word B1 that bears an association with attribute D1 of a meal that can be prepared by the time when child 51 arrives home, for example.

Moreover, first determiner 11 determines intermediate word B1 based on condition information C1 associated with grandfather 52 of the second highest priority in group G1, that is, determines intermediate words B1 with the second highest priority following that of child 51 given to grandfather 52. In particular, since the priority condition of grandfather 52 is set to the blood sugar level, first determiner 11 incorporates intermediate word B1 that bears an association with attribute D1 of a low-carbohydrate meal if the blood sugar level (the health information) satisfies a predetermined context condition.

In this manner, the priorities can be set, and thus condition information C1 associated with user 5 of a higher priority is more readily reflected in a plurality of intermediate words B1.

In this example, presentation device 2 can output, on display screen 250, a list indicating which priority is set to which person within group G1, as shown in Table 3, in accordance with the operation input from user 5. Therefore, each user 5 can browse the set content regarding the current priorities in group G1 with ease.

### (2.6) Description of Operation

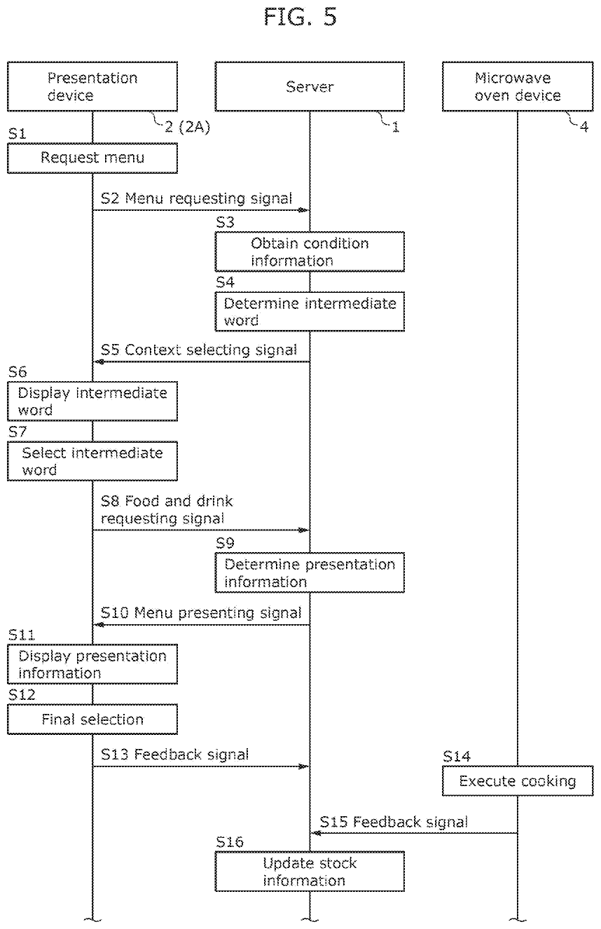

In the following section, an operation of information presentation system 100 according to the present embodiment will be described briefly with reference to FIG. 5. It is to be noted that the order in the following description of the operation is merely an example, and there is no particular limitation on the order.

At home 200, mother 50 serving as cook X1 starts the cooking app in presentation device 2A and logs in to the cooking app by inputting her user ID and password. Moreover, mother 50 performs an input operation to request a menu proposal concerning a supper for that day, for example, via the cooking app (step S1). In response to receiving the input operation from mother 50, presentation device 2A transmits a menu requesting signal to server 1 (step S2).

In response to receiving the menu requesting signal, server 1 requests information necessary within condition information C1 at that point in time (information indicating the current location or the like) from presentation devices 2 of all users 5 in group G1 associated with the input user ID and obtains such information (step S3). Then, server 1 determines a plurality of intermediate words B1 based on condition information C1 (first determining step: step S4). In this example, as illustrated in FIG. 1, mother 50, child 51, and grandfather 52 of the four family members are at home, and father 53 is not at home since he is at work. Server 1 estimates that father 53 is currently at work based on the current location of father 53. As a result, intermediate words B1 may include a word bearing an association with father 53 who is not at home.

Upon determining the plurality of intermediate words B1, server 1 generates a context selecting signal, transmits the generated context selecting signal to presentation device 2A, and presents mother 50 with the plurality of intermediate words B1 (first presenting step: step S5).

In response to receiving the context selecting signal, presentation device 2A displays the plurality of intermediate words B1 on display screen 250 of display 25A (step S6). Presentation device 2A receives a selection from the plurality of intermediate words B1 through a tapping operation or the like performed by mother 50 (step S7). Then, presentation device 2A generates a food and drink requesting signal indicating selected intermediate word B1 and transmits the generated food and drink requesting signal to server 1 (step S8).

In response to receiving the food and drink requesting signal, server 1 determines presentation information A1 corresponding to intermediate word B1 selected by user 5 by referring to food and drink data M2 (second determining step: step S9). Server 1 generates a menu presenting signal including information pertaining to determined presentation information A1 (in this example, the seasoned boiled komatsuna), transmits the generated menu presenting signal to presentation device 2A, and presents mother 50 with presentation information A1 (second presenting step: step S10).

In response to receiving the menu presenting signal, presentation device 2A displays presentation information A1 on display screen 250 of display 25A (step S11). Once mother 50 decides to cook proposed presentation information A1 for the supper for that day, mother 50 makes the final selection via a tapping operation or the like (step S12).

Presentation device 2A transmits a feedback signal including the selection result to server 1 (step S13). Moreover, mother 50 executes the cooking by use of microwave oven device 4 based on presentation information A1 of the final selection (step S14), and then microwave oven device 4 transmits a feedback signal including the cooking result to server 1 (step S15).

In response to receiving the feedback signals from presentation device 2A and microwave oven device 4, server 1 estimates the type and the amount (the number of pieces, the weight, and so on) of the foodstuffs that may have been used for that menu item based on the selection result and the cooking result and updates the stock information in user data M3 (step S16). Moreover, at this timing, for example, learner 18 updates the model (for machine learning) so as to factor in the selection result and the cooking result.

In this manner, with information presentation system 100 according to the present embodiment, a plurality of intermediate words B1 are presented upon being determined based on condition information C1 associated with user 5. Therefore, user 5 is presented with presentation information A1 only by selecting intermediate word B1 that user 5 finds of interest from the plurality of intermediate words B1. In other words, unlike the technique disclosed in PTL 1, information presentation device 100 according to the present embodiment saves user 5 from thinking of and inputting a word that works like intermediate word B1. As a result, the present embodiment provides advantageous effects of improving the user-friendliness for user 5 and allowing the intention of user 5 to be reflected more readily.

As compared to the time when information presentation system 100 starts being used initially, intermediate word B1 that better matches the lifestyle pattern, the preferences, and so on of given user 5 is more likely to be presented via learner 18 as the number of times intermediate word B1 and presentation information A1 are selected through the request for a menu proposal made on a daily basis. In particular, there may be a case where cook X1 does not have a grasp of details of the current situations (the contexts) of other users 5 in group G1, and in this respect as well, information presentation system 100 can present intermediate words B1 and presentation information A1 where the situations of other users 5 are taken into account.

### (3) Variations

The foregoing embodiment is merely one of various embodiments of the present disclosure. Various modifications can be made to the foregoing embodiment in accordance with the design and so on as long as the object of the present disclosure can be achieved. Moreover, a function similar to that of information presentation system 100 according to the foregoing embodiment may be implemented in the form of an information presentation method, a computer program, or a non-transitory recording medium having a computer program recorded thereon.

In the following section, some variations of the foregoing embodiment will be described. The variations described hereinafter can be combined as appropriate. In the following description, the foregoing embodiment may also be referred to as a basic example.

Information presentation system 100 according to the present disclosure includes a computer system. The computer system mainly includes a processor and a memory as its hardware. The function of information presentation system 100 according to the present disclosure is implemented as the processor executes a program recorded on the memory of the computer system. The program may be recorded in advance on the memory of the computer system, provided via an electrical communication circuit, or provided with the program recorded on a non-transitory recording medium, such as a memory card, an optical disc, or a hard disk drive, that is readable by the computer system. The processor of the computer system is constituted by one or more electronic circuits including a semiconductor integrated circuit (IC) or a large scale integration (LSI). An integrated circuit such as an IC or an LSI referred to herein may be called by a different term depending on the degree of integration, and an integrated circuit includes a system LSI, a very large scale integration (VLSI), or an ultra large scale integration (ULSI). Furthermore, a field-programmable gate array (FPGA) that is programmed after an LSI is manufactured or a logic device that allows reconfiguration of joining relationship within an LSI or reconfiguration of circuit segmentation within an LSI can also be employed as a processor. A plurality of electronic circuits may be integrated into a single chip or distributed between a plurality of chips. A plurality of chips may be integrated into a single device or distributed between a plurality of devices. The computer system as used herein includes a microcontroller that includes one or more processors and one or more memories. Therefore, the microcontroller is also constituted by one or more electronic circuits including a semiconductor integrated circuit or a large scale integration.

Moreover, it is not essential that a plurality of functions of information presentation system 100 be integrated within a single housing. For example, the constituent elements of information presentation system 100 may be distributed between a plurality of housings. Conversely, the plurality of functions of information presentation system 100 may be integrated within a single housing. Furthermore, at least one of the functions of information presentation system 100, or for example, one or more of the functions of information presentation system 100 may be implemented by a cloud (cloud computing) or the like.

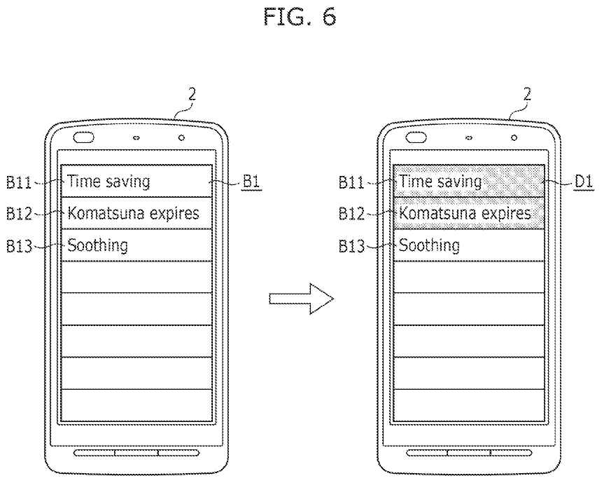

In the basic example, a plurality of intermediate words B1 are displayed on display screen 250 of display 25A of presentation device 2 with each intermediate word B1 provided with a circular or elliptic tag. Alternatively, a plurality of intermediate words B1 may be displayed in the list form, as illustrated in FIG. 6. In the list form as well, it is preferable that intermediate words B1 be displayed in the descending order of recommendability.

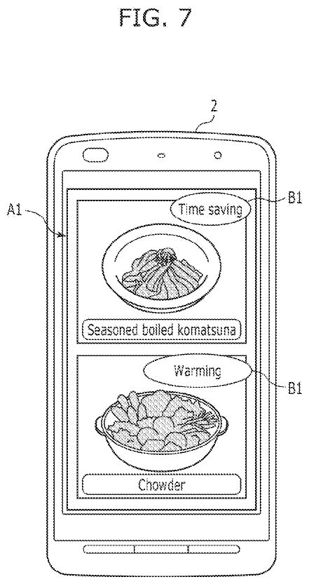

In the basic example, one item of presentation information A1 is displayed on one screen. Alternatively, two items of presentation information A1 (a seasoned boiled komatsuna and a chowder) may be displayed on one screen, as illustrated in FIG. 7. Moreover, presentation information A1 and intermediate word B1 may be displayed as a set so that user 5 can see intermediate word B1 that has played a role when server 1 has determined presentation information A1. User 5 can readily see from the example illustrated in FIG. 7 that the seasoned boiled komatsuna has been determined based on intermediate word B1 “time saving” that user 5 has selected and that the chowder has been determined based on intermediate word B1 “warming” that user 5 has selected.

In the basic example, meal information (presentation information A1) serves as information pertaining to a menu item to be cooked and its recipe. Alternatively, meal information may be information pertaining to an eat out or a home meal replacement. Specifically, if user 5 selects “eat out” or “home meal replacement” as intermediate word B1, information presentation system 100 may present, as presentation information A1, store information of a supermarket, a restaurant, or the like located in the area surrounding home 200. In this case, server 1 obtains map information pertaining to a store, such as a supermarket or a restaurant, from an external server and stores the map information therein. Then, server 1 searches for a store located in the area surrounding home 200 or the area along the path between home 200 and the work location of father 53. If server 1 has obtained information pertaining to a special sale at a supermarket or the point award system of a restaurant from an external server, server 1 presents intermediate words B1 such as “special sale” or “point award system”. If user 5 shows his or her interest in such intermediate word B1, server 1 proposes, as presentation information A1, information indicating the store name and its position information or a menu item included in the point award system (or a foodstuff or a ready-prepared dish that is on special sale).

In the basic example, only mother 50 owning presentation device 2A is authorized to select intermediate word B1 from a plurality of intermediate words B1. Alternatively, a context selecting signal may be transmitted to presentation devices 2 of other users 5 within group G1, and other users 5 may also be authorized to select intermediate word B1 from a plurality of intermediate words B1. Moreover, each presentation device 2 may output a chat window on display screen 250 so that users 5 within group G1 can consult with each other as to which intermediate word B1 and presentation information A1 to select from the plurality of presented intermediate words B1 and the presented items of presentation information A1. In this case, information presentation system 100 can also provide a platform for a family meeting regarding menu items to be cooked.

In the basic example, mother 50 serves as cook X1. Alternatively, if another user 5 within group G1, for example, father 53 is to serve temporarily as cook X1, father 53 requests a menu to be presented by use of his own presentation device 2D. In this case, information presentation system 100 basically causes presentation device 2D to present intermediate words B1 and presentation information A1.

In the basic example, mother 50 serving as cook X1 requests a menu proposal from presentation device 2 while she is at home. For example, mother 50 serving as cook X1 may request a menu proposal from presentation device 2 while she is out (e.g., while she is shopping). In this case, information presentation system 100 may be configured to allow the user situation pertaining to the current location of user 5 to have a large influence on the determination of intermediate words B1.

In the basic example, information presentation system 100 determines and presents intermediate words B1 triggered by receiving a request for a menu proposal from user 5 (mother 50). Alternatively, information presentation system 100 may automatically start the process of determining intermediate words B1 at a predetermined time, for example, and may notify (present to) presentation device 2 through a push notification or the like.

In the basic example, presentation information A1 includes meal information pertaining to a meal. Presentation information A1 may include information pertaining to music, a book, a video, or the like, in place of information pertaining to a meal.

### (4) Specific Examples of Embodiment

In the following section, more specific examples of the foregoing embodiment will be described.

### (4.1) Configuration of Specific Examples

In the following section, a specific example in which a meal proposal, or a proposal pertaining to a meal, is presented as presentation information will be described. In this example, a meal proposal is a concept that includes presenting a recipe for a menu including a menu item or a plurality of menu items and proposing a meal that involves cooking as well as proposing a meal that does not involve cooking, such as an eat out or a home meal replacement. In the following description, configurations that can be regarded as being substantially equivalent to those of the foregoing embodiment are given identical reference characters, and description of such configurations may be omitted by making a reference to the foregoing description.

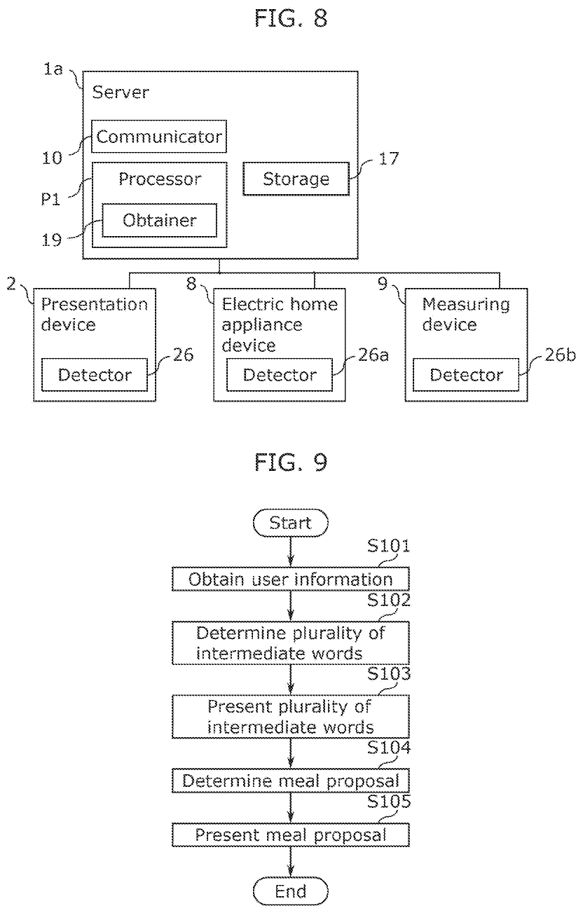

In the specific example described below, server la illustrated in FIG. 8 is used in place of server 1 illustrated in FIG. 1 described above. FIG. 8 is a block diagram illustrating a functional configuration of a presentation system according to a specific example of the embodiment. Although FIG. 8 omits the components included in server 1 that have been described above, server la includes components similar to those of server 1 described above.

Specifically, server la differs from server 1 in that server la further includes obtainer 19. Obtainer 19 is a processor for obtaining user information associated with user 5 and is implemented as a predetermined program is executed by use of a processor and a memory. For example, obtainer 19 is implemented as one function of processor P1. Obtainer 19, for example, obtains information associated with user 5 from detectors provided in various devices. Therefore, obtainer 19 is connected to and can communicate with the detectors provided in the various devices via communicator 10 or the like, for example. The information obtained in this example will be described later in further detail. The detectors from which obtainer 19 obtains information may include, in addition to detector 26 provided in presentation device 2, detector 26a of electric home appliance device 8 owned by user 5 and detector 26b of measuring device 9 owned by user 5. Moreover, obtainer 19 can also obtain user information from, for example but not limited to, various external systems. This configuration will also be described later.

As described above, in this specific example, information presentation system 100 is information presentation system 100 that presents user 5 with a meal proposal selected from a plurality of meal proposals. Therefore, each of the intermediate words in this specific example is a word that bears an association with an attribute pertaining to one or more meal proposals among the plurality of meal proposals.

Information presentation system 100 in this specific example operates as described below. FIG. 9 is a flowchart illustrating an operation of an information presentation system according to a specific example of the embodiment. As illustrated in FIG. 9, first, obtainer 19 obtains user information associated with user 5 (obtaining step S101). Next, first determiner 11 determines condition information associated with user 5 based on the obtained user information and determines a plurality of intermediate words based on the condition information (first determining step S102). The condition information according to this specific example will be described later in conjunction with the user information.

Next, first presenter 13 presents user 5 with the plurality of intermediate words such that user 5 can select one or more intermediate words from the plurality of intermediate words (first presenting step S103). Next, second determiner 12 determines, of the plurality of meal proposals, a meal proposal corresponding to the one or more intermediate words that user 5 has selected (second determining step S104). Next, second presenter 14 presents user 5 with the determined meal proposal (second presenting step S105). This operation provides advantageous effects of offering improved user-friendliness and allowing the intention of user 5 to be more readily reflected in a meal proposal.

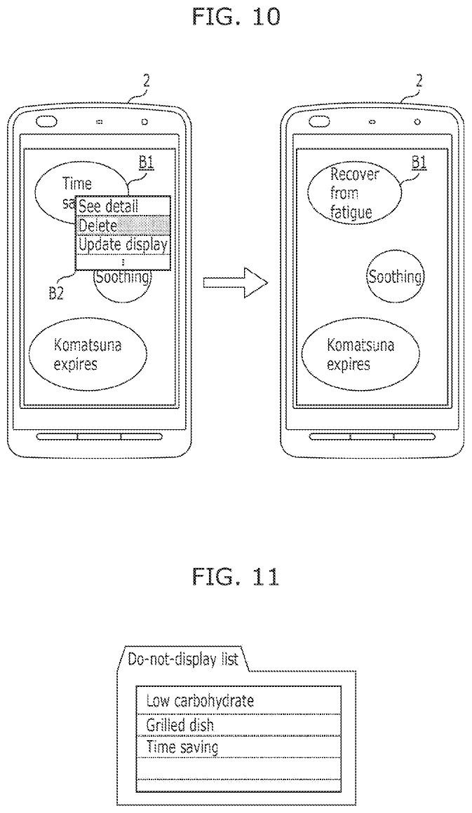

Moreover, an intermediate word presented as described above can be deleted as user 5 determines to do so. For example, FIG. 10 is a diagram illustrating an example of how an intermediate word is deleted according to a specific example of the embodiment. In FIG. 10, the drawing in the left shows intermediate words B1 presented before a deletion request is transmitted, and the drawing in the right shows intermediate words B1 presented after the deletion request has been transmitted. As illustrated in FIG. 10, user 5 can make a request as to whether each one of intermediate words B1 presented should be deleted individually. For example, user 5 taps and holds intermediate word B1 to be deleted on display screen 250. Then, submenu B2 is displayed for this intermediate word B1. User 5 can select “delete” from this submenu B2, and then intermediate word B1 that user 5 has selected is deleted.

Deleting an intermediate word herein includes setting the intermediate word temporarily to a non-presented state as well as setting the intermediate words permanently to a non-presented state. For example, information such as “komatsuna expires” about which the notification has a more significant meaning to user 5 may be appropriate to be presented again when user 5 buys komatsuna again in future and this komatsuna nears its expiration date. In contrast, presentation that reflects an action characteristic that user 5 takes, such as “time saving”, is preferably disabled permanently if user 5 desires that such an intermediate word be not presented. Therefore, the configuration according to this specific example allows user 5 to select whether a given intermediate word should be set to a non-presented state temporarily or permanently. Such a selection is made as user 5, for example, selects “delete” or “permanently delete” (not illustrated) as desired.

Intermediate word B1 that user 5 has selected to delete permanently is managed as illustrated in FIG. 11, for example. FIG. is a diagram illustrating an example of a do-not-display list according to a specific example of the embodiment. As illustrated in FIG. 11, intermediate word B1 selected to be deleted permanently is registered into a do-not-display list. Such a do-not-display list is stored in storage 17 or the like and is updated each time user 5 selects to delete intermediate word B1 permanently.

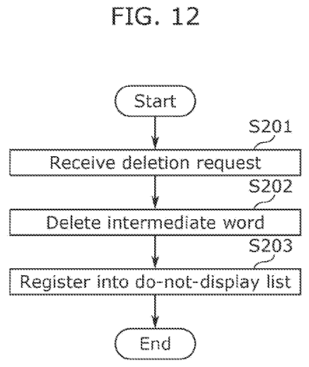

When deleting intermediate word B1, information presentation system 100 operates as described below. FIG. 12 is a flowchart illustrating an operation pertaining to how an intermediate word is deleted according to a specific example of the embodiment. As illustrated in FIG. 12, first, processor P1 receives an input of a deletion request from user 5 via inputter 24 or the like of presentation device 2 (first receiving step S201). In response to receiving the deletion request, processor P1 changes an image presented by presentation device 2 and deletes intermediate word B1 to be deleted among the plurality of presented intermediate words B1 (step S202). Furthermore, processor P1 determines whether this deletion request is for a temporary deletion or for a permanent deletion (not illustrated). If the deletion request is for a permanent deletion, processor P1 registers intermediate word B1 to be deleted into a do-not-display list (registering step S203).

Thereafter, at first determining step S102, first determiner 11 determines to present a plurality of intermediate words that are based on the condition information and that excludes the intermediate word to be deleted as registered in the do-not-display list. As a result, intermediate word B1 registered in the do-not-display list ceases to be displayed in the process thereafter. In this example, if the registration of given intermediate word B1 in the do-not-display list is canceled based on a separate operation performed by user 5, this intermediate word B1 may be allowed to be presented again.

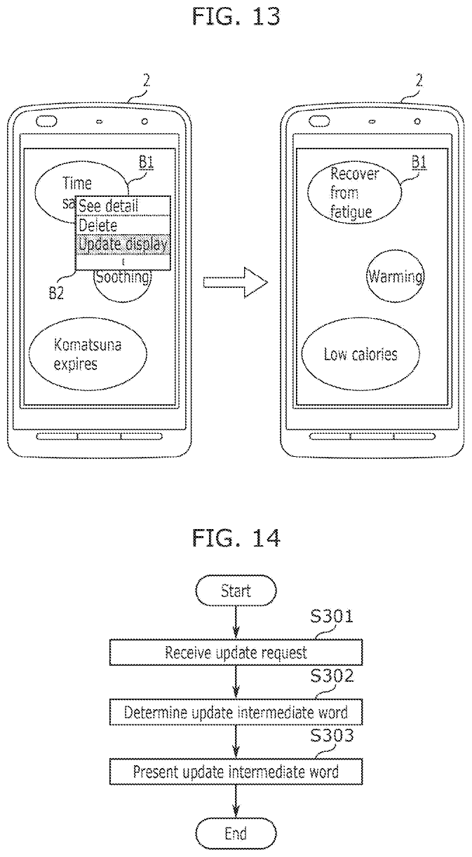

Moreover, the display of intermediate words B1 presented as described above can be updated as user 5 determines to do so. For example, FIG. 13 is a diagram illustrating an example of how intermediate words are updated according to a specific example of the embodiment. In FIG. 13, the drawing in the left shows intermediate words B1 presented before an update request is transmitted, and the drawing in the right shows intermediate word B1s presented after the update request has been transmitted. As illustrated in FIG. 13, if user 5 determines that presented intermediate words B1 do not include intermediate word B1 that user 5 finds of interest, user 5 can request that displayed intermediate words B1 be updated. For example, user 5 taps and holds a certain location on display screen 250 where intermediate words B1 are presented. This causes submenu B2 to be displayed. User 5 can select “update display” from submenu B2, and this causes new intermediate words B1 to be displayed in place of presented intermediate words B1.

When updating intermediate words B1, information presentation system 100 operates as described below. FIG. 14 is a flowchart illustrating an operation pertaining to how intermediate words are updated according to a specific example of the embodiment. As illustrated in FIG. 14, first, processor P1 receives an input of an update request from user 5 via inputter 24 or the like of presentation device 2 (second receiving step S301). In response to receiving the update request, a third determiner (not illustrated) included in processor P1, based on the condition information, determines a plurality of update intermediate words that differ from the plurality of intermediate words presented at first presenting step S102 and that are updated intermediate words B1 (third determining step S302). Furthermore, a third presenter (not illustrated) included in processor P1 presents user 5 with the plurality of update intermediate words such that user 5 can select one or more update intermediate words (third presenting step S303).

The third determiner described above may be implemented by first determiner 11. In this case, first determiner 11 is an example of the third determiner. Moreover, the third presenter described above may be implemented by first presenter 13. In this case, first presenter 13 is an example of the third presenter. For example, first determiner 11 determines more intermediate words B1 than first determiner 11 is to present when determining intermediate words B1, and first determiner 11 presents some of these intermediate words B1 that are ranked higher in accordance with a predetermined criterion. Thereafter, in response to receiving an update request, first presenter 13 may present new next-ranking intermediate word B1 among the plurality of intermediate words B1 determined by first determiner 11. This configuration makes it possible to present an update intermediate word seamlessly without involving a process of determining new intermediate word B1.

Moreover, learner 18 described according to the foregoing embodiment may learn the tendency of intermediate words B1 that user 5 do not want to be presented with based on the deletion and the display update of intermediate words B1 described above. A learning model generated as a result of this learning can be used to determine whether an intermediate word candidate tentatively determined when first determiner 11 determines intermediate words is intermediate word B1 that should or should not be presented to user 5.

Aside from the above, in this specific example, of presented intermediate words B1, intermediate word B1 that is selected highly frequently can be presented in a manner that allows user 5 to select that intermediate word B1 more easily. Specifically, obtainer 19 further obtains a selection frequency indicating the frequency that each of a plurality of intermediate words B1 presented previously has been selected. Then, at first presenting step S103, intermediate words B1 are presented such that intermediate word B1 with a higher selection frequency is presented in a more prominent manner, for example, in accordance with the selection frequency. A more prominent manner may be, for example, a manner in which the tag described above has a greater size, a manner in which given intermediate word B1 is in a different color from the rest of intermediate words B1, or a manner in which given intermediate word B1 is given a tag of a different shape from the rest of intermediate words B1. In this example, a more prominent manner in this example may be any manner that can make given intermediate word B1 more noticeable to user 5 than the rest of intermediate words B1.

Furthermore, in this specific example, information pertaining to the value to a foodstuff that is based on the degree of rareness or the price of the foodstuff owned by user 5 is obtained, and intermediate word B1 is presented in a manner corresponding to the obtained value of the foodstuff. Therefore, obtainer 19 obtains information pertaining to the value of each foodstuff owned by user 5. For example, obtainer 19 may obtain the name and the price of each foodstuff that user 5 has purchased through a website or the like, or automatically collect information pertaining to the rareness by use of the name of such a foodstuff and generate a tag associated with the name of that foodstuff. Moreover, since the value of a foodstuff is largely dependent on the individual perception of user 5, information presentation system 100 may store in advance the preferences and so on of user 5 regarding foodstuffs and calculate the value based on such preferences.

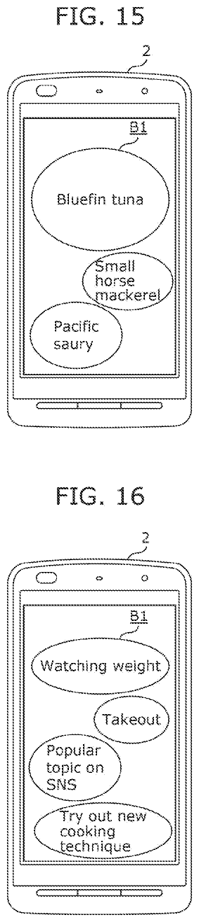

As a result of the above, a plurality of intermediate words B1 can be presented in a manner corresponding to the value of each foodstuff at first presenting step S103. For example, FIG. 15 is a diagram illustrating an example of intermediate words presented in a manner corresponding to the values of foodstuffs according to a specific example of the embodiment. As illustrated in FIG. 15, intermediate word B1 such as “bluefin tuna” that is relatively expensive is presented in a more prominent manner than intermediate words B1 such as “Pacific saury” and “small horse mackerel” that are relatively inexpensive. To be more specific, intermediate word B1 such as “bluefin tuna” that is relatively expensive is presented in a manner in which the tag therefor is larger than the tags for the rest of intermediate words B1. In this example as well, as long as intermediate word B1 is presented in a more prominent manner as the value of the foodstuff is higher, there is no particular limitation on the manner of presentation.

Furthermore, through a combination with the presentation of an intermediate word pertaining to the expiration date of a foodstuff as described earlier in the example of intermediate word B1 “komatsuna expires”, a bluefin tuna, which is more expensive than a Pacific saury or a small horse mackerel, that is nearing its expiration date may be presented more prominently to indicate that the bluefin tune is nearing its expiration date. For example, a bluefin tuna may be presented prominently when, for example, days remaining till the expiration date of the Pacific saury or the small horse mackerel is one and days remaining till the expiration date of the bluefin tuna is two. In this manner, the value of a foodstuff may be used to, for example, adjust the threshold regarding the manage-by date when presenting an intermediate word pertaining to the expiration date of the foodstuff. Moreover, for foodstuffs with the same expiration date, intermediate words B1 may be presented simply in a manner representing their prominences with respect to the value of these foodstuffs. For example, when days remaining till the expiration date of the Pacific saury and the bluefin tuna is one, the bluefin tuna may be presented in a more prominent manner with a larger tag given thereto, as illustrated in FIG. 15.

### (4.2) Relationship Between User Information and Condition Information

In the following section, a relationship between user information and condition information according to this specific example will be described. For example, in this specific example, intermediate words B1 that are based on the obtained user information are presented, as illustrated in FIG. 16. FIG. 16 is a diagram illustrating an example of intermediate words presented based on user information according to a specific example of the embodiment. As illustrated in FIG. 16, intermediate words B1 presented in this specific example may include, for example but not limited to, intermediate word B1 related to improving the health level of user 5 (“watching weight” in FIG. 16), intermediate word B1 that goes along an action estimated from an action characteristic of user (“popular topic on SNS” in FIG. 16), intermediate word B1 pertaining to a meal that user 5 can prepare within an allotted cooking time (“takeout” in FIG. 16), or intermediate word B1 for promoting improvement in the cooking ability of user 5 (“try out new cooking technique” in FIG. 16). Each of the above will be described below in further detail.

### (4.2.1) Condition Information in Terms of Health Level

First, user information pertaining to improving the health level of user 5 will be described. In this example, the user information is obtained from, for example but not limited to, an external schedule management system, measuring device 9, or electric home appliance device 8. The user information includes, for example, a schedule pertaining to the date on which user 5 exercises. In addition, the user information includes, for example but not limited to, vitals information of user 5 obtained from a non-portable, portable, or body implant-type device, such as a blood pressure monitor, a blood sugar level monitor, a cleansing toilet seat with hot water spray feature, a scale, an activity tracker, or a thermometer, which are examples of measuring device 9. Moreover, the user information includes information pertaining to the sleep deficit based on the time difference between when user 5 falls asleep and when user 5 wakes up or the quality of sleep obtained from a device such as bedding, an illumination device, or an air conditioning device, which are examples of electric home appliance device 8. Moreover, the user information includes, for example but not limited to, information pertaining to the date or the position information obtained from a device such as a time measuring device, which is an example of presentation device 2 or electric home appliance device 8.

Moreover, the user information includes, for example but not limited to, a test result, such as the value from a test performed at a medical facility, or a diagnosis result, such as the name of an illness that user 5 has and has been diagnosed of. Such user information can be obtained as user 5 obtains these items of information by capturing an image of a sheet with the diagnosis result written thereon by use of a camera or the like or via a network cooperating with a server or the like at the medical facility. Moreover, the user information may be obtained from an application that information presentation system 100 cooperates with and that is related to fitness such as running or exercise. From the cooperating application, for example, information pertaining to the basic health-related functions, such as the history of running and exercise, the physical information, the heart rate, the blood pressure, and the amount of activity is obtained as the user information. If the cooperating application is configured to store the user information into a storage server or the like on the network, the user information may be obtained from the storage server or the like via the cooperating application. The user information includes, for example but not limited to, information pertaining to the date or the position information obtained from a device such as a time measuring device, which is an example of presentation device 2 or electric home appliance device 8.

For example, as the condition information determined based on the user information described above, the target or the like of nutrition intake is set in accordance with the information indicating the health level of user 5 or the exercise that user 5 engages in. Then, an intermediate word corresponding to this set nutrition intake is determined. For example, if the amount of exercise that user 5 engages in is large, it is possible to estimate, as the condition information, that user 5 is trying to increase his or her muscular strength. Therefore, intermediate word B1 such as “increase muscular strength efficiently” is presented, and also a meal proposal that includes a relatively large amount of proteins is presented. In addition, for example, if the amount of exercise that user 5 engages in is small, it is possible to estimate, as the condition information, that user 5 is hoping to keep his or her weight from increasing. Therefore, intermediate word B1 such as “watching weight” is presented, and also a meal proposal for a low-calorie meal is presented. In this example, in a case where user 5 has a meal late at night as well, in a similar manner, intermediate word B1 such as “watching weight” is presented, and a meal proposal for a low-calorie meal is presented.

Moreover, for example, in a case where the fact that the intestinal environment is not well is detected from the state of bodily wastes of user 5, it is possible to estimate, as the condition information, that user 5 is trying to bring the intestinal environment to normal. Therefore, intermediate word B1 such as “improve stomach condition” is presented, and also a meal proposal for a meal with adjusted prebiotics or probiotics is presented. Moreover, for example, in a case where the fact that user 5 is having a period or is pregnant is detected based on the state of the bodily wastes of user 5, it is possible to estimate, as the condition information, that user 5 is hoping for a support from the meals during the period or the pregnancy. Therefore, intermediate word B1 such as “support period or pregnancy” is presented, and also a meal proposal for a meal that can supplement a micronutrient, such as iron or folic acid, that tends to become deficient during the period or the pregnancy is presented.

Moreover, for example, in a case where the state of urinary sugar abnormality or like is detected from the state of bodily wastes of user 5, it is possible to estimate, as the condition information, that user 5 is hoping to improve the diabetes or the like. Therefore, intermediate word B1 such as “watching blood sugar level” is presented, and also a meal proposal for a meal that controls the increase in the blood sugar level is presented. In addition to this meal proposal, a good way to eat the meal in order to control the increase in the blood sugar level, for example, may also be presented. Moreover, for example, in a case where the state of high blood pressure or the like is detected from the state of blood pressure level of user 5, it is possible to estimate, as the condition information, that user 5 is hoping to improve the high blood pressure. Therefore, intermediate word B1 such as “watching blood pressure level” is presented, and also a meal proposal for a meal with a low salt content is presented.

Moreover, for example, in a case where the state of high fatigue or the like is detected from the state indicating the amount of activity or the like of user 5, it is possible to estimate, as the condition information, that user 5 is hoping to recover from the fatigue. Therefore, intermediate word B1 such as “recover from fatigue for tomorrow” is presented, and also a meal proposal for a vitamin-balanced meal, for example, is presented.

Moreover, for example, as the condition information determined based on the user information described above, being able to reduce the cooking load or to gain a soothing effect by a meal, for example, is set in accordance with the information indicating the stress level, the sleep deficit, or the like of user 5. Then, an intermediate word corresponding to such a set cooking load or soothing effect is determined. For example, in a case where the state of an excessive amount of activity or the sleep deficit of user 5 is detected, it is possible to estimate, as the condition information, that user 5 is hoping to reduce the cooking load or to gain a soothing effect from a meal. Therefore, intermediate word B1 such as “rest and refresh” is presented, and also a meal proposal for a meal that does not involve many cooking steps or utilizes a home-delivery service or a meal proposal for a meal expected for a soothing effect is presented.

In this manner, in this specific example, the user information may include information pertaining to the health level of user 5, and the condition information may include information pertaining to the condition for improving the health level of user 5.

### (4.2.2) Condition Information in Terms of Action Characteristics

Next, user information pertaining to an action estimated from an action characteristic of user 5 will be described. In this example, the user information is obtained from, for example but not limited to, a web server, electric home appliance device 8, an external schedule management system, or a sensor device. The user information includes, for example, an item of information that user 5 has felt positive about among items of information that user 5 has come across via a website or the like (e.g., information that user 5 liked or for which user 5 has posted a positive comment on a social network service (SNS)). Moreover, the user information includes, for example, information that user 5 has come across via an information home appliance, such as a TV (such information is based on information such as channel information and program information). For example, as the condition information determined based on the user information described above, a genre or the like of a related meal proposal is set in accordance with the target that user 5 finds of interest. For example, in a case where a specific local area is detected as the target that user 5 finds of interest, it is possible to estimate, as the condition information, that user 5 is hoping to experience a meal related to that specific local area. Therefore, intermediate word B1 such as “local dish” is presented, and also a meal proposal for a traditional dish or the like in that specific local area is presented. Moreover, for example, in a case where a predetermined dish is detected as the target that user 5 finds of interest, it is possible to estimate, as the condition information, that user 5 is hoping to experience a meal similar to that predetermined dish. Therefore, intermediate word B1 such as “genre of dish: A” is presented, and also a meal proposal for, for example, a dish of the genre to which the predetermined dish belongs is presented.

Meanwhile, for example, with regard to a target detected as the condition information determined based on the user information described above, even if user 5 finds the target of interest, if that target is something that user 5 has already experienced or a sufficient amount of time has not passed since the last time user 5 experienced that target, information presenting system 100 is configured to avoid the genre or the like of a meal proposal associated with such a target.

Moreover, the user information includes, for example, a schedule, such as an event, that allows user 5 to have an out of the ordinary experience. In such a case, as the condition information determined based on the user information described above, the genre or the like of a related meal proposal is set in accordance with the event in which user 5 will participate. For example, in a case where the Doll Festival, the midsummer day of the Ox, or the like is detected as an event in which user 5 will participate, it is possible to estimate, as the condition information, that user 5 is hoping to experience a meal related to such an event. Therefore, intermediate word B1 such as “dish for the Doll Festival” is presented, and also a meal proposal for a dish or the like having a connection with that event is presented.

Moreover, the user information includes, for example, information on the weather, such as a difference in temperature between daytime and nighttime on that day, that may cause user 5 to narrow down the candidates for a meal. For example, in a case where a difference in temperature of five degrees or more is detected, it is possible to estimate, as the condition information, that user 5 is hoping to experience a hot meal or a cold meal. Therefore, intermediate word B1 such as “warming dish” is presented, and also a meal proposal for a hot dish or the like is presented.

Moreover, the user information includes, for example, information indicating the time when and the location where an available foodstuff is determined. For example, in a case where the current time and the location of user 5 are detected, it is possible to estimate, as the condition information, that user 5 is hoping for a meal that user 5 can prepare with foodstuffs that are least expensive and available at a store that user 5 can get to from the current location before its closing time. Therefore, intermediate word B1 such as “purchase foodstuffs after current time” is presented, and also a meal proposal for a dish or the like that user 5 can prepare with the foodstuffs that user 5 can obtain in the manner described above is presented. At this time, information on the store that user 5 should visit may also be presented.

Moreover, simply a schedule, such as an anniversary, may be obtained as the user information. For example, in a case where a schedule such as an anniversary is detected, it is possible to estimate, as the condition information, that user 5 is hoping to experience a meal having a connection with the anniversary. Therefore, intermediate word B1 such as “wedding anniversary” is presented, and also a meal proposal for a meal estimated from dishes enjoyed on the past wedding anniversaries is presented.

Moreover, information indicating, for example, that user 5 has come to have a favorite foodstuff may be obtained as the user information. For example, in a case where, with favorite foodstuffs of user 5 having been learned, the fact that user 5 has obtained such a favorite foodstuff is detected, it is possible to estimate, as the condition information, that user 5 is hoping for a meal prepared with the favorite foodstuff. Therefore, intermediate word B1 such as “dish prepared with lamb” is presented, and also a meal proposal for a meal prepared with lamb is presented. Moreover, for example, in a case where, with favorite foodstuffs of user 5 having been learned, the fact that user 5 has not had a meal prepared with a favorite foodstuff for quite some time is detected, it is possible to estimate, as the condition information, that user 5 is hoping for a meal prepared with the favorite foodstuff. Therefore, intermediate word B1 such as “dish prepared with lamb” may be presented, and also a meal proposal for a meal prepared with lamb may be presented.

Moreover, for example, in a case where a plurality of people are expected to share a meal as in a case of a family of a plurality of people, which of these people sharing the meal the condition information should be based on may be estimated from, for example, the selection tendency of meal proposals in the past. For example, for user 5 who selects a meal proposal flagged as being child-oriented relatively often, the user information to be obtained may be obtained from a family member indicated as a child in the family of this user 5. Meanwhile, for example, for user 5 who selects a meal proposal flagged as being adult-oriented relatively often, the user information to be obtained may be obtained from a family member indicated as an adult in the family of this user 5.

Moreover, the user information includes, for example, information pertaining to a cooking cycle of user 5. For example, in a case where the tendency where user 5 sets a relatively large amount of cooking time on the first day and the third day of the consecutive seven days is obtained, it is possible to estimate, as the condition information, that user 5 is hoping to cook in quantity on the first day and the third day. Therefore, intermediate word B1 such as “cook in quantity” is presented on the first day and the third day of the consecutive seven days, and also a meal proposal for a dish or the like that user 5 can cook and keep is presented. Meanwhile, intermediate word B1 such as “time saving” is presented on the second day and the fourth to seventh days, and also a meal proposal centered on consuming the dish of dishes that user 5 has cooked and kept is presented.

Moreover, the user information includes, for example, information pertaining to the cooking tendency of user 5. For example, in a case where, with information pertaining to the usage tendency of cooking appliances where user 5 tends to use a microwave oven relatively often or tends to use a grill relatively often or information pertaining to the cooking tendency where user 5 often prepares a deep fried dish or a one plate dish having been learned, the fact that user 5 has obtained a foodstuff or the like that matches such a tendency is detected, intermediate word B1 such as “usual” is presented, and also a meal proposal for a dish or the like that matches the cooking tendency described above is presented.

In this manner, in this specific example, the user information may include information pertaining to an action characteristic of user 5, and the condition information may include information pertaining to the condition matching an action estimated from the action characteristic of user 5.

### (4.2.3) Condition Information in Terms of Allotted Cooking Time

Next, user information pertaining to a meal that can be prepared within an allotted cooking time of user 5 will be described. In this example, the user information is obtained from, for example but not limited to, an external schedule management system, electric home appliance device 8, or a sensor device. The user information includes, for example, a schedule pertaining to the time that user 5 cannot use for cooking. Moreover, the user information includes information indicating, for example but not limited to, the operation situation obtained from a device such as a washing machine, a vacuum cleaner, or a dishwasher, which are examples of electric home appliance device 8. Moreover, the user information includes, for example but not limited to, information pertaining to the activity situation of user 5 and the amount of remaining housework indicating the amount of housework that has not been done as obtained from a device such as a camera, a microphone, or a thermal image sensor, which are examples of the sensor device. Moreover, the user information may include, for example but not limited to, information pertaining to the level of busyness of user 5 determined through, for example, machine learning based on the number of times a dedicated app has been started, the timing at which a push notification is tapped, or the like obtained from presentation device 2.

For example, as the condition information determined based on the user information described above, a cooking time or the like in which user 5 can prepare a meal within an allotted cooking time is set based on the time that user 5 cannot use for cooking, the operation situation, the activity situation, and the amount of remaining housework. Then, an intermediate word is determined in accordance with this set cooking time. For example, in a case where there is a dish that user 5 can prepare within the allotted cooking time and user 5 can prepare this dish with the available foodstuffs, it is possible to estimate, as the condition information, that user 5 is hoping to cook this dish with the available foodstuffs. Therefore, intermediate word B1 such as “can be prepared in the remaining time” is presented, and also a meal proposal for cooking this dish is presented.

Moreover, for example, in a case where there is no dish that user 5 can prepare within the allotted cooking time, it is possible to estimate, as the condition information, that user 5 is not hoping to cook any dish. Therefore, intermediate word B1, such as “eat out” or “home meal replacement” is presented, and also a store available for an eat out or a home meal replacement in the neighborhood is presented based on, for example, the position information of user 5.

Moreover, as a meal proposal presented in the process described above, a proposal may be made such that the time totaling the cooking time, the eating time, and the time needed for cleaning up afterword is contained within the allotted cooking time. For example, a meal proposal that matches the preferences of a child may be made so that it does not take much time for the child to finish the meal, or a meal proposal for a one bowl dish or the like where not many pieces of tableware are used may be presented. Moreover, in a case where the eating time falls below a predetermined threshold value, a meal proposal for a dish that can be digested with relative ease may be presented.

Meanwhile, in a case where user 5 can spare a relatively large amount of time for the allotted cooking time, intermediate word B1 such as “nutrition education” or “cook and keep” may be presented, and also a proposal for effectively using the allotted cooking time of user 5 may be presented. At this time, a helping point or the like for the nutrition education may also be presented.

In this manner, in this specific example, the user information may include information pertaining to the allotted cooking time that user 5 can use for cooking a meal, and the condition information may include information pertaining to the condition that user 5 can prepare a meal within the allotted cooking time.

### (4.2.4) Condition Information in Terms of Cooking Ability

Next, user information pertaining to promoting improvement in the cooking ability of user 5 will be described. In this example, the user information is obtained from, for example but not limited to, storage 17. The user information includes, for example, information indicating a cooking history pertaining to the history of cooking performed by user 5 in the past.

For example, as the condition information determined based on the user information described above, promoting improvement in the cooking ability of user 5 or the like is set. Then, an intermediate word is determined in accordance with this set improvement in the cooking ability. For example, in a case where the fact that user 5 has cooked at a certain level a predetermined number of times is detected based on the cooking history of user 5, it is possible to estimate, as the condition information, that user 5 is hoping to be presented with a dish that requires cooking at a level higher than the certain level. Therefore, intermediate word B1 such as “increase cooking level” is presented, and also a meal proposal for preparing the dish described above is presented. Moreover, for example, in a case where the fact that user 5 has cooked at a certain level a predetermined number of times is detected based on the cooking history of user 5, it is possible to estimate, as the condition information, that user 5 is hoping for a reward from cooking. Therefore, intermediate word B1 such as “reward for hard work” is presented, and also a meal proposal indicating that a coupon is issued and the coupon can be applied to an eat out is presented.

In this manner, in this specific example, the user information may include information pertaining to the cooking ability of user 5 cooking a meal, and the condition information may include information pertaining to the condition that promotes improvement in the cooking ability of user 5.

In this example, a word corresponding to an attribute pertaining to a meal proposal can mean a word that people can generally associate with this attribute and can be rephrased as a word associated with the attribute. Specifically, for example, examples such as “time saving” and “manage-by date” are illustrated as intermediate words B1 corresponding to the “cooking time”. Alternatively, words within a range where people can generally associate with the cooking time in terms of its length may be used, and examples include “quickly”, “can be prepared quickly”, “leisurely”, or “unhurried”. In selecting such words, some typical words are selected at the time when user 5 uses information presentation system 100. Therefore, server la may accumulate candidates for the typical words by transversally reading new websites with the later date of update per predefined period, or an administrator or the like of server la may manage the candidates for typical words by adding or deleting a candidate. Moreover, a word corresponding to the attribute individually for each user 5 may be selected by learning what types of words user 5 selects when he or she inputs a text into another application such as a text editor.

### (4.6) Summary of Specific Examples of Embodiment

As described thus far, the information presentation method according to this example is an information presentation method of presenting user 5 with a meal proposal selected from a plurality of meal proposals, and the information presentation method includes: an obtaining step of obtaining user information associated with user 5; a first determining step of determining condition information associated with user 5 based on the obtained user information and determining a plurality of intermediate words B1 based on the condition information; a first presenting step of presenting user 5 with the plurality of intermediate words B1 such that user 5 can select one or more intermediate words B1 from the plurality of intermediate words B1; a second determining step of determining, of the plurality of meal proposals, a meal proposal corresponding to one or more intermediate words B1 that user 5 has selected; and a second presenting step of presenting user 5 with the determined meal proposal. Each of the plurality of intermediate words B1 is a word that corresponds to an attribute pertaining to one or more meal proposals among the plurality of meal proposals.

According to such an information presentation method, a meal proposal for user 5 can be determined by presenting user 5 with intermediate words B1 that are based on the user information. Each intermediate word B1 is a word that user 5 is likely to select in the current situation of user 5 based on the user information. In this manner, a meal proposal that matches the situation of user 5 is presented as user 5 simply selects intermediate word B1 that matches the situation that user 5 is thinking of or feeling. Therefore, the user-friendliness for user 5 can be improved, and a meal proposal that reflects the intention of user 5 more readily can be presented.

Moreover, for example, the user information may include information pertaining to the health level of user 5, and the condition information may include information pertaining to the condition for improving the health level of user 5.

This configuration makes it possible to determine and present intermediate words B1 by obtaining the user information pertaining to the health level of user 5 and based on the condition for improving the health level of user 5.

Moreover, for example, the user information may include information pertaining to an action characteristic of user 5, and the condition information may include information pertaining to the condition that matches an action estimated from the action characteristic of user 5.

This configuration makes it possible to determine and present intermediate word B1 by obtaining the user information pertaining to an action characteristic of user 5 and based on the condition that matches an action estimated from the action characteristic of user 5.

Moreover, for example, the user information may include information pertaining to the allotted cooking time that user 5 can use for cooking a meal, and the condition information may include information pertaining to the condition that user 5 can prepare a meal within the allotted cooking time.

This configuration makes it possible to determine and present intermediate words B1 by obtaining the user information pertaining to the allotted cooking time that user 5 can use for cooking and based on the condition that user 5 can prepare a meal within the allotted cooking time.

Moreover, for example, the user information may include information pertaining to the cooking ability of user 5 cooking a meal, and the condition information may include information pertaining to the condition that promotes improvement in the cooking ability of user 5.

This configuration makes it possible to determine and present intermediate words B1 by obtaining the user information pertaining to the cooking ability of user 5 cooking a meal and based on the condition that promotes improvement in the cooking ability of user 5.

Moreover, for example, the information presentation method may further include: after the first presenting step, a first receiving step of receiving an update request from user 5; a third determining step of determining, based on the condition information, a plurality of update intermediate words different from the plurality of intermediate words B1 presented at the first presenting step, in response to receiving the update request; and a third presenting step of presenting user 5 with the determined plurality of update intermediate words such that user 5 can select one or more update intermediate words.

According to this configuration, if user 5 decides that presented intermediate words B1 do not include any word that matches his or her own thought or situation, user 5 can request that update intermediate words different from presented intermediate words B1 be presented. This configuration can increase the advantageous effects of more readily reflecting the intention of user 5.

Moreover, for example, the information presentation method may further include, after the first presenting step, a second receiving step of receiving a deletion request in which intermediate word B1 to be deleted is selected by user 5 from the plurality of intermediate words B1. In response to the deletion request being received, intermediate word B1 to be deleted may be deleted from the presented plurality of intermediate words B1.

According to this configuration, there may arise a situation where, if there is a limitation or the like on the number of intermediate words B1 to be presented, for example, presented intermediate words B1 may include intermediate word B1 that is less likely to be selected. In that case, intermediate word B1 that is less likely to be selected can be deleted, and thus the number of intermediate words B1 to be presented can be utilized at a maximum efficiency. As a result, the likelihood that intermediate words B1 that match the thought or the situation of user 5 can be presented increases, and this makes it possible to increase the advantageous effects of more readily reflecting the intention of user 5.

Moreover, for example, the information presenting method may further include a registering step of registering intermediate word B1 to be deleted into a do-not-display list in response to receiving the deletion request, and the first determining step may include determining a plurality of intermediate words B1 that are based on the condition information excluding intermediate word B1 to be deleted registered in the do-not-display list.

This configuration makes it possible to delete intermediate word B1 permanently. Therefore, intermediate word B1 that has no chance of matching the thought or the situation of user 5 can be kept from being presented thereafter. As a result, the likelihood that intermediate words B1 that match the thought or the situation of user 5 can be presented increases, and this makes it possible to increase the advantageous effects of more readily reflecting the intention of user 5.

Moreover, for example, the information presenting method may further include obtaining information pertaining to the value of a foodstuff that is based on the price or the degree of rareness of a foodstuff owned by user 5, and the first presenting step may include presenting the plurality of intermediate words B1 in a manner corresponding to the value of the foodstuff.

This configuration makes it possible to change the manner in which intermediate word B1 is displayed based on the general value or the value unique to user 5, for example. As a result, in a case where, for example, a foodstuff that is of a high value is nearing its expiration date or a foodstuff that is of a high value is left untouched after being purchased, user 5 can be reminded of such a foodstuff effectively and can be presented with a meal proposal involving this foodstuff. Accordingly, this configuration can increase the advantageous effects of improving the user-friendliness and allowing the user's intention to be reflected more readily.

Moreover, for example, the information presentation method may further include obtaining a selection frequency of each of the plurality of intermediate words B1 presented previously, and the first presenting step may include presenting the plurality of intermediate words B1 in a manner corresponding to the selection frequency.

This configuration makes it possible to distinguish between intermediate word B1 that is selected with a relatively high frequency and intermediate word B1 that is selected with a relatively low frequency or that is not selected. For example, intermediate word B1 that is selected with a relatively high frequency can be estimated to match the thought and the situation of user 5. Therefore, such intermediate word B1 can be presented in a more prominent manner. Accordingly, this configuration can increase the advantageous effects of improving the user-friendliness and allowing the user's intention to be reflected more readily.

The program according to the present example is a program that causes a computer to execute the information presentation method described above.

This configuration can provide, by use of the computer, advantageous effects similar to those of the information presentation method described above.

Information presentation system 100 according to the present example is an information presentation system that presents a user with a meal proposal selected from a plurality of meal proposals pertaining to a meal, and the information presentation system includes an obtainer, a first determiner, a first presenter, a second determiner, and a second presenter. The obtainer obtains user information associated with the user. The first determiner determines condition information associated with the user based on the obtained user information and determines a plurality of intermediate words based on the condition information. The first presenter presents the user with the plurality of intermediate words such that the user can select one or more intermediate words from the plurality of intermediate words. The second determiner determines, of the plurality of meal proposals, a meal proposal corresponding to the one or more intermediate words that the user has selected. The second presenter presents the user with the determined meal proposal. Each of the plurality of intermediate words is a word that corresponds to an attribute pertaining to one or more meal proposals among the plurality of meal proposals.

This configuration can achieve information presentation system 100 that can provide advantageous effects similar to those of the information presentation method described above.

### (5) Recapitulation

As described thus far, an information presentation method according to a first aspect is an information presentation method of presenting a user (5) with an item of presentation information (A1) selected from items of presentation information (A1). The information presentation method includes a first determining step, a first presenting step, a second determining step, and a second presenting step. At the first determining step, a plurality of intermediate words (B1) are determined based on condition information (C1) associated with the user (5). At the first presenting step, the user (5) is presented with the plurality of intermediate words (B1) such that the user (5) can select one or more intermediate words (B1) from the plurality of intermediate words (B1). At the second determining step, of the items of presentation information (A1), presentation information (A1) that corresponds to the one or more intermediate words (B1) selected by the user (5) is determined. At the second presenting step, the determined presentation information (A1) is presented to the user (5). Each of the plurality of intermediate words (B1) is a word that bears an association with an attribute (D1) pertaining to one or more items of presentation information (A1) among the items of presentation information (A1). According to the first aspect, the user-friendliness for the user (5) can be improved, and the intention of the user (5) can be reflected more readily.

With regard to an information presentation method according to a second aspect, in the first aspect, the condition information (C1) includes history information. According to the second aspect, the lifestyle pattern, the preferences, and so on of the user (5) are more readily reflected in the plurality of intermediate words (B1), and as a result, presentation information (A1) that better reflects the intention of the user (5) is more likely to be presented.

With regard to an information presentation method according to a third aspect, in the second aspect, the history information includes a history pertaining to the plurality of intermediate words (B1) presented previously to the user (5) in the first presenting step. According to the third aspect, the lifestyle pattern, the preferences, and so on of the user (5) are even more readily reflected in the plurality of intermediate words (B1).

With regard to an information presentation method according to a fourth aspect, in one of the second aspect and the third aspect, the history information includes a history pertaining to the one or more intermediate words (B1) that the user (5) has selected previously. According to the fourth aspect, the lifestyle pattern, the preferences, and so on of the user (5) are even more readily reflected in the plurality of intermediate words (B1).

With regard to an information presentation method according to a fifth aspect, in any one of the second to fourth aspects, the history information includes a history pertaining to an action that the user (5) has taken in response to being presented with the presentation information (A1) previously at the second presenting step. According to the fifth aspect, the lifestyle pattern, the preferences, and so on of the user (5) are even more readily reflected in the plurality of intermediate words (B1).

With regard to an information presentation method according to a sixth aspect, in any one of the first to fifth aspects, the presentation information (A1) includes meal information pertaining to a meal. According to the sixth aspect, the user-friendliness for the user (5) can be improved, and a proposal pertaining to a meal where the intention of the user (5) can be reflected more readily can be presented.

With regard to an information presentation method according to a seventh aspect, in the sixth aspect, the meal information includes information pertaining to a menu item to be cooked. According to the seventh aspect, the user-friendliness for the user (5) can be improved, and a proposal pertaining to a menu item to be cooked where the intention of the user (5) can be reflected more readily can be presented.

With regard to an information presentation method according to an eighth aspect, in one of the sixth aspect and the seventh aspect, at least one step of the first determining step or the second determining step includes making a determination based at least on a manage-by date of a foodstuff. According to the eighth aspect, a proposal pertaining to a meal where the manage-by date of a foodstuff is taken into consideration can be presented.

With regard to an information presentation method according to a ninth aspect, in the eighth aspect, at least one step of the first determining step or the second determining step includes making a determination based on the manage-by date and the lifestyle pattern of the user (5). According to the ninth aspect, a proposal pertaining to a meal where the lifestyle pattern of the user (5) as well as the manage-by date of the foodstuff is taken into consideration can be presented.

With regard to an information presentation method according to a tenth aspect, in any one of the sixth to ninth aspects, the information presentation method further includes a third presenting step of presenting a way of storing a specific foodstuff if the user (5) exhibits an action that negates the consumption of the specific foodstuff. According to the tenth aspect, the user-friendliness can be further improved.

With regard to an information presentation method according to an eleventh aspect, in any one of the sixth to tenth aspects, the second presenting step includes presenting the presentation information (A1) in a collective list of foodstuffs corresponding to two or more meals. The list of foodstuffs is updated in accordance with a change in the condition information (C1). According to the eleventh aspect, in a case where the condition information (C1) may change on a daily basis, for example, a list of foodstuffs that follows this change can be presented.

With regard to an information presentation method according to a twelfth aspect, in any one of the sixth to eleventh aspects, the second presenting step includes presenting the presentation information (A1) in a collective list of foodstuffs corresponding to two or more meals. The list of foodstuffs is updated in accordance with a selection result of the user (5) made on the previously presented presentation information (A1). According to the twelfth aspect, the information presentation method can present a list of foodstuffs that better reflects the lifestyle pattern, the preferences, and so on of the user (5).

With regard to an information presentation method according to a thirteenth aspect, in any one of the first to twelfth aspects, the information presentation method further includes a setting step of setting a group (G1) that includes a plurality of users (5). At least one step of the first presenting step or the second presenting step includes a presentation in the unit of group (G1). According to the thirteenth aspect, an information presentation method suited for a plurality of users (5) (e.g., suited for a family) can be provided.

With regard to an information presentation method according to a fourteenth aspect, in the thirteenth aspect, the authority to select the presentation information (A1) presented at the second presenting step is given only to a predetermined user (5) within the group (G1). According to the fourteenth aspect, the user-friendliness can be improved if the authority is given only to the person who executes a specific action (a cook) based on the presented presentation information (A1) when the group (G1) includes both that person who executes the specific action and a person who does not execute that specific action.

With regard to an information presentation method according to a fifteenth aspect, in one of the thirteenth aspect and the fourteenth aspect, priorities are set for the plurality of users (5) within the group (G1). The first determining step includes determining the plurality of intermediate words (B1) based on the condition information (C1) associated with a user (5) of a high priority. According to the fifteenth aspect, the condition information (C1) associated with the user (5) of a high priority can be more readily reflected in the plurality of intermediate words (B1).

A program according to a sixteenth aspect is a program that causes one or more processors to execute the information presentation method according to any one of the first to fifteenth aspects. The sixteenth aspect can provide a function that makes it possible to improve the user-friendliness for the user (5) and to allow the intention of the user (5) to be reflected more readily.

An information presentation system (100) according to a seventeenth aspect presents a user (5) with an item of presentation information (A1) selected from items of presentation information (A1). The information presentation system (100) includes a first determiner (11), a first presenter (13), a second determiner (12), and a second presenter (14). The first determiner (11) determines a plurality of intermediate words (B1) based on condition information (C1) associated with the user (5). The first presenter (13) presents the user (5) with the plurality of intermediate words (B1) such that the user (5) can select one or more intermediate words (B1) from the plurality of intermediate words (B1). The second determiner (12) determines, of the items of presentation information (A1), an item of presentation information (A1) corresponding to the one or more intermediate words (B1) selected by the user (5). The second presenter (14) presents the user (5) with the determined presentation information (A1). Each of the plurality of intermediate words (B1) is a word that bears an association with an attribute (D1) pertaining to one or more items of presentation information (A1) among the items of presentation information (A1). The seventeenth aspect can provide an information presentation system (100) that makes it possible to improve the user-friendliness for the user (5) and to allow the intention of the user (5) to be reflected more readily.

The configurations according to the second to fifteenth aspects are not essential to the information presentation method and can be omitted as appropriate.

1. An information presentation method of presenting a user with a meal proposal selected from a plurality of meal proposals, the information presentation method comprising:
obtaining user information associated with the user;
determining condition information associated with the user based on the user information obtained and determining a plurality of intermediate words based on the condition information;
presenting the user with the plurality of intermediate words so as to allow the user to select one or more intermediate words from the plurality of intermediate words;
determining, of the plurality of meal proposals, a meal proposal corresponding to the one or more intermediate words selected by the user; and
presenting the user with the meal proposal determined, wherein
each of the plurality of intermediate words is a word that corresponds to an attribute pertaining to one or more meal proposals among the plurality of meal proposals.

2. The information presentation method according to claim 1, wherein
the user information includes information pertaining to a health level of the user, and
the condition information includes information pertaining to a condition for improving the health level of the user.

3. The information presentation method according to claim 1, wherein
the user information includes information pertaining to an action characteristic of the user, and
the condition information includes information pertaining to a condition that matches an action estimated from the action characteristic of the user.

4. The information presentation method according to claim 1, wherein
the user information includes information pertaining to an allotted cooking time that the user can use for cooking a meal, and
the condition information includes information pertaining to a condition that allows the user to prepare a meal within the allotted cooking time of the user.

5. The information presentation method according to claim 1, wherein
the user information includes information pertaining to a cooking ability of the user cooking a meal, and
the condition information includes information pertaining to a condition for promoting improvement in the cooking ability of the user.

6. The information presentation method according to claim 1, further comprising: after the presenting the user with the plurality of intermediate words,
receiving an update request from the user;
determining, based on the condition information, a plurality of update intermediate words different from the plurality of intermediate words presented at the presenting the user with the plurality of intermediate words, in response to the receiving of the update request; and
presenting the user with the plurality of update intermediate words determined so as to allow the user to select one or more update intermediate words.

7. The information presentation method according to claim 1, further comprising: after the presenting the user with the plurality of intermediate words,
receiving a deletion request in which an intermediate word to be deleted is selected by the user from the plurality of intermediate words; and
deleting the intermediate word to be deleted from the plurality of intermediate words presented, in response to receiving the deletion request.

8. The information presentation method according to claim 7, further comprising:
registering the intermediate word to be deleted into a do-not-display list, in response to receiving the deletion request, wherein
the determining of the condition information includes determining a plurality of intermediate words that are based on the condition information excluding the intermediate word to be deleted registered in the do-not-display list.

9. The information presentation method according to claim 1, further comprising:
obtaining information pertaining to a value of a foodstuff, the value being based on a price or a degree of rareness of the foodstuff owned by the user, wherein
the presenting the user with the plurality of intermediate words includes presenting the plurality of intermediate words in a manner corresponding to the value of the foodstuff.

10. The information presentation method according to claim 1, further comprising:
obtaining a selection frequency of each of the plurality of intermediate words presented previously, wherein
the presenting the user with the plurality of intermediate words includes presenting the plurality of intermediate words in a manner corresponding to the selection frequency.

11. A non-transitory computer readable recording medium having recorded thereon a program that causes a computer to execute the information presentation method according to claim 1.

12. An information presentation system that presents a user with a meal proposal selected from a plurality of meal proposals pertaining to a meal, the information presentation system comprising:
an obtainer that obtains user information associated with the user;
a first determiner that determines condition information associated with the user based on the user information obtained and determines a plurality of intermediate words based on the condition information;
a first presenter that presents the user with the plurality of intermediate words so as to allow the user to select one or more intermediate words from the plurality of intermediate words;
a second determiner that determines, of the plurality of meal proposals, a meal proposal corresponding to the one or more intermediate words selected by the user; and
a second presenter that presents the user with the meal proposal determined, wherein
each of the plurality of intermediate words is a word that bears an association with an attribute pertaining to one or more meal proposals among the plurality of meal proposals.
